(19) United States
(12) Patent Application Publication
(10) Pub. No.: US 2016/0364707 A1
(43) Pub. Date: Dec. 15, 2016

(54) Potentate: A Cryptography-Obfuscating, Self-Policing, Pervasive Distribution System For Digital Content

(71) Applicant: Pradeep Varma, Gurgaon (IN)

(72) Inventor: Pradeep Varma, Gurgaon (IN)

(21) Appl. No.: 14/928,851

(22) Filed: Oct. 30, 2015

(30) Foreign Application Priority Data
Jun. 11, 2015 (IN) 1753/DEL/2015

(51) Int. Cl. G06Q 20/12; G06F 21/50; G06F 9/445; G06F 21/60; G06F 21/10

(52) U.S. Cl. CPC G06Q 20/1235; G06F 21/602; G06F 21/10; G06F 8/61; G06F 21/50; G06F 2221/0748; G06F 2221/034; G06Q 2220/18

(57) ABSTRACT

A system and method for self-policed, authenticated, offline/online, viral marketing and distribution of content such as software, text, and multimedia with effective copyright and license enforcement and secure selling. The system is based on key and cryptography hiding techniques, using source-to-source transformation for efficient, holistic steganography that systematically inflates and hides critical code by: computation interleaving; flattening procedure calls and obfuscating stack by de-stacking arguments; obfuscating memory management; and encoding scalars as pointers to managed structures that may be distributed and migrated all over the heap using garbage collection. Multimedia/text content may be partitioned and sold with expiry dates for protection and updates for long life. Authenticity of software installed on a machine may be monitored and ensured, supporting even authentic software deployment in an unknown environment. The system can be implemented with commonplace networking or browser software, commonplace hardware and content provision over a secure website (https standard).

### FIELD OF THE INVENTION

This disclosure is about propagation and copyright enforcement of software-based assets such as software, software appliances, devices with embedded software, text, books, music, games, and videos in general and the obfuscation of the required cryptography support in particular. Furthermore, this disclosure is about software capabilities comprising hidden cryptography, auto copyright and license enforcement, self authentication, authenticity enforcement, self duplication, self demonstration, self marketing including incentives, and self selling securely with multiple payment or free schemes.

### BACKGROUND OF THE INVENTION

U.S. Pat. No. 6,266,654 and related patents (U.S. Pat. No. 7,065,508, U.S. Pat. No. 7,085,743, U.S. Pat. No. 7,089,212, U.S. Pat. No. 7,092,908, U.S. Pat. No. 7,158,954, U.S. Pat. No. 7,209,901, U.S. Pat. No. 7,249,103, U.S. Pat. No. 7,330,837) discuss software sales where lineages are tracked, a copy can be used for sale or propagation and marketing incentives provided for such sales. Kirovski et al. in U.S. Pat. No. 7,8188,11 B2 discuss multimedia sales similarly and provide a public-key scheme for authenticating transactions, involving keys per party including buyer, seller, and service provider along with specialized hardware as an elaborate means for preventing fraud. Left unfulfilled is a need for authenticated, software sales of freely copied and marketed software, whereby no keys or key infrastructure are required of the retail participants—buyers, sellers—and commonplace hardware is used. Left unfulfilled is a need for protection against masqueraders who substitute genuine software with fake or fraudulent software. Left unfulfilled is a need to protect the working of genuine software from masqueraders who supply a fake computing environment for a genuine software to work in, in an effort to capture or break the cryptographic underpinnings of the distributed software and to discover any keys distributed with the software.

Much work has transpired to design software that hides cryptography implementation including keys and data from the scrutiny of hostile parties running and testing the software on untrusted systems. Listed below is the prominent prior art and literature on the subject.

Collberg et al. in U.S. Pat. No. 6,668,325 and other literature (Christian Collberg, Clark Thomborson, and Douglas Low, “Manufacturing cheap, resilient, and stealthy opaque constructs”, In Proceedings of the 25th ACM SIGPLAN-SIGACT symposium on Principles of programming languages (POPL '98), ACM, New York, N.Y., USA, pages 184-196. DOI=10.1145/268946.268962, http://doi.acm.org/10.1145/268946.268962; C. Collberg, C. Thomborson, and D. Low,” Breaking Abstractions and Unstructuring Data Structures”, In Proceedings of IEEE International Conference on Computer Languages (ICCL '98), May 1998, pages 28-38. DOI=10.1109/ICCL.1998.674154 http://dx.doi.org/10.1109/ICCL.1998.674154; and Christian S. Collberg and Clark Thomborson, “Watermarking, tamper-proofing, and obfuscation: tools for software protection”, IEEE Transactions on Software Engineering Volume 28, Issue 8 (August 2002), 735-746. DOI=10.1109/TSE.2002.1027797 http://dx.doi.org/101109/TSE.2002.1027797) disclose methods to obfuscate (Java) programs comprising (a) opaque predicates that serve to hide control flow behind irrelevant (conditional) statements that do not contribute to the actual computations (b) splitting and encoding of Boolean variables as integers with Boolean operators implemented over the resulting integers, (c) Java class obfuscation by adding classes and refactoring the class inheritance graph, (d) obfuscate arrays by splitting them into subarrays, or merging them into superarrays, or increasing/decreasing the number of array dimensions (e) obfuscating procedures by inlining calls, outlining code into new procedures, using application-specific bytecode interpreters, and cloning procedures (f) constructing strings dynamically (g) merging scalars such as two 32-bit integers into larger scalars (a 64-bit integer), encoding integers (e.g. represent i as c₁i+c2) and promoting scalars to objects (e.g. an integer to the Integer class in Java). Pointer aliases are identified as particularly useful for constructing opaque predicates due to the intractability of pointer analysis. Building bogus pointer data structures for application obfuscation is recommended so that opaque predicates can be constructed using the pointers such as based on some hidden invariant that two pointer variables are or are not aliases of each other. One cost of such bogus structures that is noted is heap space exhaustion due to data bloat in the obfuscated code compared to the original code.

Horning et al. in U.S. Pat. No. 7,430,670 disclose methods including obfuscation methods with a binary modification tool comprising: rearranging/splitting/duplicating basic blocks, rearranging code within a basic block and inserting null instructions, obstruct binary code analysis, string encryption, obstruct decompilation to source constructs using code replication, code fusion etc. to introduce irreducible flow graphs, using overlays to make address tracing difficult, protecting jumps, obfuscation using concurrency, and program optimization as obfuscation. They point out that pointer analysis and similarly array subscript analysis is intractable and hence opaque predicates can be constructed using them. Variables can be allocated out of a contiguous array space, replacing individual variable access with an index into the array. A variable stored thus can be an array itself, with its contiguous elements stored contiguously or otherwise in the space.

Farrugia et al. in U.S. Pat. No. 8,434,061 present an approach to specifically, shuffle, split and expand an array into a set of arrays so that individual data items are spread in memory. Access to an array element occurs using simple accessor functions such as de_obfuscate_array(number, 5), which can be used to access the 5th element of the directly identified, original array number from its distributed set of bits in memory. The method however, spreads bits as-is in memory, using a one-to-one mapping, as encoded in the accessor function, for looking up each bit in it new memory position in place of the original one. Thus the obfuscation is limited, with an obfuscated memory image being only a permutation of an un-obfuscated memory image.

Lattner et al. in U.S. Pat. No. 8,645,930 present a clubbed, single recursive function implementation of multiple functions to present one obfuscated, common function in place of the individual ones. Within the common function body, a goto-based dispatch is implemented for the specific sub-function indicated by an argument. The argument identifies the original unclubbed function call that in turn identifies the subpart of the common function body to be run through. The common function mechanism is then implemented without using system stack, by implementing the stack explicitly in heap with push and pop operations carried out on the heap stack explicitly in the source code. This technique thus still implements the stack functionality. Also it adds run-time costs in clubbing multiple functions in one common recursive function for the obfuscation it attains.

Farrugia et al. in U.S. Pat. No. 8,707,053 disclose a method of carrying out a Boolean operation such as XOR on masked versions of data and then unmasking the result for further computation, as and when necessary. The masking is carried out using a mapping function that maps a datum to its masked equivalent. Improvement over prior art is mentioned, where masking, by an XOR bit/datum is noted to be easily broken by the knowledge of the bit, with masking by function being mentioned as harder to break with a single bit/datum leak. Unfulfilled in this mathematical transformation approach however, is invulnerability to recognition of the algebraic transformations involved on the stored data and inversion of the same. Also unfulfilled, is a need to not allow an unmasked result, post unmasking, to be read from the memory image by an adversary.

Zhou et al. in U.S. Pat. No. 7,634,091 disclose a method of obfuscating a part of the private key in public key crypt systems such as RSA (Rivest Shamir Adleman) and El Gamal so that the key can still be used in deciphering data. Muir et al. in WO 2011120125 A1 disclose a digital signature method against white-box attacks that does not store a private key in the clear, unlike a public key and uses a transformed generator to carry out the digital signature generation process without using the private key in the clear. Left unfulfilled in these specific cryptographic methods is a need for a uniform software-transforming technique to hide the keys and encryption/decryption process in not only these crypt systems, but also in other crypt systems, such as symmetric encryption systems.

Cappaert et al. in Jan Cappaert and Bart Preneel, “A general model for hiding control flow”, in Proceedings of the tenth annual ACM workshop on Digital rights management (DRM '10), ACM, New York, N.Y., USA, 35-42, DOI=10.1145/1866870.1866877, http://doi.acm.org/10.1145/1866870.1866877, discuss a flattened control flow graph wherein each transfer to a basic block is mediated by a dispatcher that can jump to any basic block, with the label for the jump being stored as a runtime value accessed by a one-way transition function and branch functions such that minimum information (e.g. a secret value) for hiding from the program can be specified such that control flow information is not leaked. The secret value needs to be kept and passed separately to the program at run-time, which in effect makes the secret value a key, which then leaves the key-hiding problem unsolved.

A memory management technique by Ruwase et al. (O. Ruwase and M. S. Lam, “A practical dynamic buffer overflow detector”, In Proceedings of the 11th Annual Network and Distributed System Security(NDSS) Symposium, pages 159-169, February 2004) represents an out-of-bounds pointer value with an address of an out-of-bounds object that is created and managed by the memory management system in a dedicated hash table. The out-of-bounds object stores the out-of-bounds pointer value in itself, along with a pointer to a referent object. Since no garbage collection is used, all out-of-bounds objects for a referent object are deleted when the referent object is deleted, to prevent memory leaks from occurring. The hash table is kept, specifically for this purpose—when a referent object is reclaimed, the hash table is traversed, deleting all out-of-bounds objects pointing to that referent object. This technique is inapplicable for an obfuscatory purpose for two reasons. One, the hash table is a giveaway; all objects contained in it are known to be encodings of out-of-bounds pointer values. Two, an out-of-bounds pointer value may survive the deletion of its referent object, for example as a dangling pointer. The pointer may participate in normal computation thereafter, e.g. pointer arithmetic and comparisons, so its obfuscated encoding needs to survive the deletion of the referent object. This the Ruwase et al. scheme is unable to provide, given that preventing memory leaks while not relying on garbage collection is motivational. Hence Ruwase et al. although useful for designing bounds checkers in memory safety systems, is not useful for a cryptography obfuscation purpose.

The Ruwase et al. scheme above is not capable of handling pointers beyond out-of-bounds pointers. Similarly, smart pointer schemes proposed for C++ only handle a subset of pointers (base pointers to whole objects) ignoring pointers such as interior pointers, out-of-bounds pointers, dangling pointers and so on. The coverage of scalars, by object casts, e.g. int to Integer in Java, or int to object in C# does not extend to pointer types (a pointer is not a valid type in Java). Thus no scheme in prior art is capable of a pointer encoding of all scalars. Further the schemes in prior art suffer from a need to re-use an encoding, e.g. Integer(1) for all instances of 1, which compromises the obfuscation value of the scheme by offering the re-use mechanism or table of encodings as a direct giveaway.

Each one of these prior art or literature references suffers from one or more of the following disadvantages: incomplete program obfuscation, and unnecessary obfuscation cost. Glaring in particular is the omission of techniques for heap-efficient pointer and memory management, procedure and stack obfuscation by optimization avoiding unnecessary computation, and steganography, using which extreme obfuscation can be obtained at an extremely low cost.

For the foregoing reasons, there is a need for improvement in cryptography hiding or obfuscating techniques relevant to the strict requirements of software comprising a distribution system. The strict requirements include hiding of keys and data circulated with a distribution system to run under hostile scrutiny on an untrusted system. For wide reach, a distribution system has to run with a small resource footprint on stock hardware with no extra capabilities. The two needs, for extreme obfuscation, and extremely low budget or high efficiency, are simultaneously sought to be met for a desired advancement in distribution systems comprising self-policing capabilities of self-authentication, effective copyright and license enforcement, and secure selling while supporting both online and offline (viral) modes of asset distribution.

### SUMMARY OF THE INVENTION

In this disclosure, using commonplace browser software and stock hardware like mobiles, PCs, laptops, desktops, and servers, and content provision over a secure website (https standard), we disclose a system for self-policed, authenticated, offline and online, viral marketing and distribution of content such as software and multimedia with effective copyright and license enforcement and secure selling capabilities. The system, in particular, does not require any public key infrastructure, with inexpensive symmetric encryption sufficing for all its needs (beyond the https standard). The system protects against masqueraders who try to substitute the software with fake or fraudulent entities, and also against masqueraders who try to substitute the environment a genuine software tries to run in.

The system is based on novel key, data, and cryptography hiding techniques for software. The system uses source-to-source transformation for efficient, holistic steganography that systematically inflates critical code computation, thereby hiding it, by:

1. Interleaving in varying depth, the key, secret data and cryptography code with standard application code, with or without concurrent primitives.

2. Flattening classes into a class-less program.

3. Flattening procedure calls and obfuscating stack by de-stacking arguments.

4. Obfuscating memory management by replacing scalars by scalarised fat scalars, comprising encoding as pointers providing an invariant that critical data fields or keys are never exposed in any memory image during computation and data may be distributed all over the heap. The memory manager works with or without garbage collection capabilities, supporting data migration.

5. Untyping the run-time image by obfuscating symbol table and type and object metadata information, and further destabilizing fields and control flow.

A distribution system for binary-encoded digital assets is disclosed. The system comprises a hiding means for hiding one or more keys or cryptography implementation in a digital asset. The system further comprises a copying means for asset distribution wherein a functionally-restricted asset copy is received for use or further distribution, directly or as a further copy, with or without access to a computer network. The system further comprises a self-policing means for enforcing asset safety, comprising an authentication means for an un-authenticated, digital asset wherein encrypted credentials data using one or more keys or cryptography implementation hidden in the asset are constructed for authentication by an authenticated digital asset or website. The self-policing means further comprises a secure selling means for an authenticated digital asset wherein either a sale transaction is carried out directly, securely, or the sale is delegated to a separate secure means, identifying the delegation by an encrypted identifier constructed using one or more keys or cryptography implementation hidden in the asset. The response from the secure means is decrypted using the one or more keys or cryptography implementation hidden in the asset to determine the success of the sale. The self-policing means further comprises a copyright and license enforcement means for an asset wherein encryption and decryption of computing context and other data using one or more keys or cryptography implementation hidden in the asset are carried out. Functionally-unrestricted asset use is permitted only after the asset has been sold and licensed to run in a recognizable computing context.

According to an embodiment, a digital asset comprises software.

According to another embodiment, the asset further comprises a combination of encrypted video, audio, or text data bundled with the software. The software is a software player to decrypt and play the data or encrypt and add data.

According to yet another embodiment, the bundled software thwarts simple data capture mechanisms comprising one or more of screen bitmap capture, screen text clip capture, screen text clipboard capture, or audio clip capture.

According to an embodiment, the hidden keys or cryptography implementation of the software comprises an expiry date or mechanism so that the software does not work after the date or mechanism disallows it.

According to another embodiment, the software enables a free or priced update with a continuing digital asset of different hidden keys or cryptography implementation, upon expiry of the software.

According to an embodiment, the update recurs with a well-announced expiry date for planning convenience.

According to an embodiment, the bundled data decrypted or encrypted by the hidden keys or cryptography implementation of the software player is reduced to a small partition so that the remaining one or more partitions may be bundled with one or more other software players, each distributed with its own distinct hidden keys or cryptography implementation.

According to an embodiment, the distribution system installs an authenticated digital asset on a machine where installed software consists of authenticated assets only.

According to another embodiment, the asset installation is mediated by a monitoring system on the machine.

According to yet another embodiment, the asset installation updates an expired or expiring asset with a successor asset of different hidden keys or cryptography implementation.

According to yet another embodiment, the update recurs with a well-announced expiry date for planning convenience.

According to an embodiment, the asset installation installs and periodically updates an authenticated browser.

According to an embodiment, the monitoring system disallows unmediated asset installation by resetting execution permission or disallowing a file with execute permission to run, or stopping a running software.

According to an embodiment, secure selling is carried out even on a machine with un-authenticated software.

According to an embodiment, no plaintext fragment of encrypted data is exposed to a user, other than possibly only sale-related input such as buyer details or payment details.

According to yet another embodiment, the computing context and other data are stored with the digital asset after sale and installation.

According to yet another embodiment, the credentials data constructed by a digital asset are passed to a browser to authenticate.

According to yet another embodiment, a key is stored in a digital asset by distribution into a subset of a large number of candidate data fields in the asset, the reconstruction of the key from the fields not being apparent from a reverse engineered control flow of the asset, forcing a combinatorially large number of key reconstructions to be considered in a key search making key discovery infeasible.

A cryptography hiding system for hiding one or more keys or cryptography implementation in a binary-encoded digital asset using holistic, efficient steganography is disclosed. The system comprises an interleaving means for sequentially or concurrently interleaving the computation of non-cryptography, useful code with cryptography code. The system further comprises an obfuscating memory management means for creating an encoded pointer representation of a scalar, comprising one or more encoding pointers pointing to one or more objects created and managed by the memory management means for maintaining the scalar in an obfuscated state throughout the lifetime of the scalar. The system further comprises a class obfuscation means for translating a class to one or more data structures or procedures. The system further comprises a procedure obfuscation means for de-stacking one or more parameters of a procedure or translating a procedure call to jumps to and from an inlined procedure body.

A cryptography hiding system for hiding one or more keys or cryptography implementation in a binary-encoded digital asset using holistic, efficient steganography is disclosed. The system comprises an interleaving loop or recursive procedure instantiating one or more re-entrant calls to one or more procedures or macros in cryptography code, such that one or more re-entrant calls to one or more procedures or macros in useful, non-cryptography code are interspersed in-between any two cryptography code calls. A cryptography call typically comprises a smaller stateful computation than a larger stateful computation comprised by a non-cryptography call.

According to an embodiment, the interleaving loop or recursive procedure is parallelized to execute a cryptography call largely in parallel with non-cryptography computation.

An obfuscating memory management system for creating an encoded pointer representation of a scalar is disclosed. The system comprises one or more encoding pointers pointing to one or more objects created and managed by the memory management system for maintaining the scalar in an obfuscated state throughout the lifetime of the scalar.

According to an embodiment, the objects are laid out randomly over the heap memory.

According to another embodiment, an encoding pointer is used only once in encoding a scalar part.

According to yet another embodiment, an object comprises one or more fields containing one or more pointers to one or more allocated objects. The value denoted by an encoding pointer can be obtained by dynamic computation comprising the use of a combination of the object, one or more of the pointers, one or more of other pointers, and the allocated objects.

According to yet another embodiment, the one or more pointers to allocated objects contained in fields of the object further denote a value of a reference count for an encoding pointer. The value can be obtained by dynamic computation comprising the use of a combination of the object, one or more of the pointers, one or more of other pointers, and the allocated objects.

According to yet another embodiment, the memory management system increments the reference count upon dynamically finding a scalar part's encoding pointer using a filter function.

According to yet another embodiment, the memory management system reclaims the object upon reference count elimination.

According to yet another embodiment, the memory management system reclaims or migrates one or more of the object or allocated objects using garbage collection.

According to yet another embodiment, the memory management system never stores a scalar or scalar part directly in memory.

According to yet another embodiment, the memory management system scalarizes the scalar into independent encoding pointers.

According to yet another embodiment, the memory management system distributes an aggregate object's scalars’ encoding pointers all over the object.

According to yet another embodiment, the memory management system distributes a set of aggregate objects' scalars' encoding pointers all over the objects.

According to yet another embodiment, the memory management system further redistributes the encoding pointers in the set of aggregate objects, upon increase or decrease of objects in the set due to allocation or de-allocation.

According to yet another embodiment, the memory management system defers an object de-allocation till a further re-distribution vacates the de-allocated object prior to the de-allocation.

According to yet another embodiment, the memory management system initializes the scalar using dynamic computation comprising the use of a set of literals excluding the literal initializing the scalar in an un-obfuscated program code.

According to yet another embodiment, an object comprises one or more fields denoting a value for an encoding pointer or reference count. The value can be obtained by dynamic computation comprising the use of the object.

According to yet another embodiment, the encoding pointer representation of the scalar is changed when one or more objects pointed to by one or more encoding pointers are migrated by garbage collection. The scalar's value denotation remains unchanged.

An obfuscating memory management system is disclosed. The system allocates or de-allocates an object with meta-data comprising object size or layout. The contents of the object may be obfuscated by distribution or re-distribution, part by part, anywhere over the object or one or more other objects.

According to an embodiment, the memory management system defers an object's deallocation till occupants of the object in lieu of parts distributed or re-distributed to other objects have been vacated.

According to another embodiment, an object is allocated with larger storage than its meta-data size, so that false scalars or duplicated parts may be used to fill the extra space for further obfuscation.

According to an embodiment the memory management system comprises a garbage collector.

According to another embodiment, the garbage collector uses the layout metadata to identify or de-obfuscate pointer scalars in the object.

According to an embodiment, the memory management system scalarizes the object's parts in substitution for object allocation on the stack. The object's encoding pointers are independently stored.

According to another embodiment, the memory management system enables part-by-part scalarization of all stack-allocated variables of a procedure. The variables are shifted to heap allocation only if the variables comprise a pointer scalar.

According to an embodiment, the object meta-data itself is obfuscated.

A procedure obfuscation system for de-stacking one or more procedure parameters is disclosed. The system comprises a static analyzer means capable of guidance by one or more user annotations and a source-to-source transformer means capable of replacing a reference to a procedure parameter with a non-stack reference.

According to an embodiment, the user annotations comprise sharpening a symbolic value of a variable, location or expression to a subset of a symbolic value generated by a static analyzer.

According to another embodiment, the non-stack reference comprises a global variable.

According to yet another embodiment, the static analyzer means comprises a means for determining that a procedure call has no nested calls to the procedure.

According to yet another embodiment, the static analyzer means further comprises a means for determining that the number of nested procedure calls to a procedure contained within a call to the same procedure is less than a statically-known constant. The non-stack reference further comprises a global array variable indexed at a nesting depth of a procedure call.

According to yet another embodiment, the static analyzer means further comprises a means for determining that barring procedure return values, all dependencies within a procedure are intra-procedural. The source-to-source transformer means comprises a means for replacing a procedure with a parameter memoising procedure.

According to yet another embodiment, the static analyzer means further comprises a means for computing a schedule of calls for a recursive computation involving a procedure. The source-to-source transformer means comprises invoking the procedure according to the schedule in a loop or recursion.

A computing context storing system is disclosed. A computing context comprises a narrow time window within which the computing context is stored in the computing environment.

According to an embodiment, narrow time windows or exact times of creation or modification of one or more files or folders along with their locations in a computing environment further comprise the computing context.

According to another embodiment, the partial content of one or more files or folders along with their locations in a computing environment further comprise the computing context.

According to yet another embodiment, the names of one or more files or folders along with their locations in a computing environment further comprise the computing context.

According to yet another embodiment, functional data related to the accurate working of the computing environment further comprises the computing context.

A computing context recognition system for handling and recognizing a changing computing context is disclosed. The system stores a computing context to re-construct the computing context from the stored data later. The later context is recognized to be that of the same computing environment for which the context was stored, if the reconstructed context matches a freshly computed context for more than a preset, passing number of stored context entities.

According to an embodiment, after a computing context is recognized, a revised computing context is stored in place of the earlier stored computing context, for more accurate recognition of a computing context later.

According to another embodiment, functional data related to the accurate working of the computing environment further comprises the computing context.

A distribution system for a multimedia and text combination asset is disclosed. The asset comprises a software player that hides one or more keys or cryptography implementation within itself and is bundled with a combination of video, audio, or text data in encrypted form. The software player can decrypt and play the data or encrypt and add data, without requiring any customer-specific symmetric or asymmetric key or password to be input or made available during installing or running the player.

According to an embodiment, the software player thwarts simple data capture mechanisms comprising one or more of screen bitmap capture, screen text clip capture, screen text clipboard capture, or audio clip capture.

According to another embodiment, the hidden keys or cryptography implementation of the software player comprises an expiry date or mechanism so that the player does not work after the date or mechanism disallows it.

According to yet another embodiment, the software player enables a free or priced update with a continuing player of a different hidden keys or cryptography implementation, upon expiry of the player.

pow According to an embodiment, the update recurs with a well-announced expiry date for planning convenience.

According to another embodiment, data bundled with the software player is reduced to a small partition. The remaining one or more data partitions may be bundled and distributed with one or more other software players, each comprising distinct hidden keys or cryptography implementation.

According to an embodiment, no plaintext fragment of encrypted data is exposed by the distribution system to a user, other than possibly only sale-related input such as buyer details or payment details.

A software authentication and installation monitoring system is disclosed. The system comprises a means for hiding one or more keys or cryptography implementation. The system further comprises a means for tracking authentic software or certified software or user-built software installed on a machine by storing the information in encrypted form on the machine using the hidden keys or cryptography implementation. The system further comprises a means for mediating in a software installation, ensuring that authentication steps are carried out that ensure the authenticity of the installed software. The system further comprises a means for disallowing a user setting the permission of a file to execute, unless the file is known to be built or certified by the user or known to be authentically installed as per the tracked information. The system further comprises a means for disallowing an executable file to run, unless the file is built or certified by the user or known to be authentically installed as per the tracked information. The system further comprises a means for stopping a running program, if the running program is found to not be user built or certified, or authentically installed as per the tracked information. The system further comprises a means for scanning the machine periodically, resetting the execute permissions of any unknown files.

According to an embodiment, the system updates an expired or expiring software with a successor software having different hidden keys or cryptography implementation.

According to another embodiment, the update recurs with a well-announced expiry date for planning convenience.

According to an embodiment, the system installs and periodically updates an authenticated browser.

According to an embodiment, no plaintext fragment of encrypted data is exposed by the system to a user.

A distribution method for binary-encoded digital assets is disclosed. The method comprises a hiding step for hiding one or more keys or cryptography implementation in a digital asset. The method further comprises a copying step wherein a functionally-restricted asset copy is received for use or further distribution, directly or as a further copy, with or without access to a computer network. The method further comprises a self-policing step for enforcing asset safety, comprising an authentication step for an un-authenticated, digital asset wherein encrypted credentials data using one or more keys or cryptography implementation hidden in the asset are constructed for authentication by an authenticated digital asset or website. The self-policing step further comprises a secure selling step for an authenticated digital asset wherein either a sale transaction is carried out directly, securely, or the sale is delegated to a separate secure means, identifying the delegation by an encrypted identifier constructed using one or more keys or cryptography implementation hidden in the asset. The response from the secure means is decrypted using the one or more keys or cryptography implementation hidden in the asset to determine the success of the sale. The self-policing step further comprises a copyright and license enforcement step for an asset wherein encryption and decryption of computing context and other data using one or more keys or cryptography implementation hidden in the asset are carried out. Functionally-unrestricted asset use is permitted only after the asset has been sold and licensed to run in a recognizable computing context.

A cryptography hiding method for hiding one or more keys or cryptography implementation in a binary-encoded digital asset using holistic, efficient steganography is disclosed. The method comprises an interleaving step for interleaving sequentially or concurrently, the computation of non-cryptography, useful code with cryptography code. The method further comprises an obfuscating memory management step for creating an encoded pointer representation of a scalar, comprising the use of one or more encoding pointers pointing to one or more objects created and managed for maintaining the scalar in an obfuscated state throughout the lifetime of the scalar. The method further comprises a class obfuscation step for translating a class to one or more data structures or procedures. The method further comprises a procedure obfuscation step for de-stacking one or more parameters of a procedure or translating a procedure call to jumps to and from an inlined procedure body.

A cryptography hiding method for hiding one or more keys or cryptography implementation in a binary-encoded digital asset using holistic, efficient steganography is disclosed. The method comprises the step of using an interleaving loop or recursive procedure for instantiating one or more re-entrant calls to one or more procedures or macros in cryptography code, such that one or more re-entrant calls to one or more procedures or macros in useful, non-cryptography code are interspersed in-between any two cryptography code calls. A cryptography call typically comprises a smaller stateful computation than a larger stateful computation comprised by a non-cryptography call.

An obfuscating memory management method for creating an encoded pointer representation of a scalar is disclosed. The method comprises the step of using one or more encoding pointers pointing to one or more objects created and managed for maintaining the scalar in an obfuscated state throughout the lifetime of the scalar.

An obfuscating memory management method is disclosed. The method comprising the step of allocating or de-allocating an object with meta-data comprising object size or layout such that the contents of the object may be obfuscated by distribution or re-distribution, part by part, anywhere over the object or one or more other objects.

A procedure obfuscation method for de-stacking one or more procedure parameters is disclosed. The method comprises a static analysis step guided by one or more user annotations, and a source-to-source transformation step replacing a reference to a procedure parameter with a non-stack reference.

A computing context storing method is disclosed. The method comprises a step of storing a computing context within a narrow time window part of the computing context.

A computing context recognition method is disclosed. The method comprises a step of storing a computing context. The method further comprises a step of re-constructing the computing context from the stored data later, recognizing the later context to be that of the same computing environment for which the context was stored, if the reconstructed context matches a freshly computed context for more than a preset, passing number of stored context entities.

A distribution method for a multimedia and text combination asset is disclosed. The method comprises a step of encrypting or decrypting a combination of video, audio or text data bundled with a software player, using the hidden keys or cryptography implementation of the software player such that no customer-specific symmetric or asymmetric key or password is required to be input or made available during the installing or running of the player.

A software authentication and installation monitoring method is disclosed. The method comprises the steps of (a) hiding one or more keys or cryptography implementation; (b) tracking authentic software or certified software or user-built software installed on a machine by storing the information in encrypted form on the machine using the hidden keys or cryptography implementation; (c) mediating in a software installation, ensuring that authentication steps are carried out that ensure the authenticity of the installed software; (d) disallowing a user setting the permission of a file to execute, unless the file is known to be built or certified by the user or known to be authentically installed as per the tracked information; (e) disallowing an executable file to run, unless the file is built or certified by the user or known to be authentically installed as per the tracked information; (f) stopping a running program, if the running program is found to not be user built or certified, or authentically installed as per the tracked information; and (g) scanning the machine periodically, resetting the execute permissions of any unknown files.

The systems and methods disclosed herein are all operable in a computing environment.

### BRIEF DESCRIPTION OF THE DRAWINGS

To further clarify the above and other advantages and features of the disclosure, a more particular description will be rendered by references to specific embodiments thereof, which are illustrated in the appended drawings. It is appreciated that the given drawings depict only some embodiments of the method, system, computer program and computer program product and are therefore not to be considered limiting of its scope. The embodiments will be described and explained with additional specificity and detail with the accompanying drawings in which:

FIG. 1 shows a flowchart depicting the process of asset distribution and licensing.

FIG. 2 illustrates the process of authenticating a potent or potentate.

FIG. 3 illustrates the process of saving and evolving a stored context.

FIG. 4 illustrates the copyright protection and distribution of assets comprising multimedia and text data.

FIG. 5 gives an overview of obfuscation techniques.

FIG. 6 illustrates the means of procedure obfuscation by de-stacking parameters.

FIG. 7 illustrates the obfuscating memory manager.

FIG. 8 illustrates the structure of multimedia/text potents.

FIG. 9 illustrates the structure of an authentic client monitor.

FIG. 10 illustrates a computer system in which the asset distribution system may be implemented.

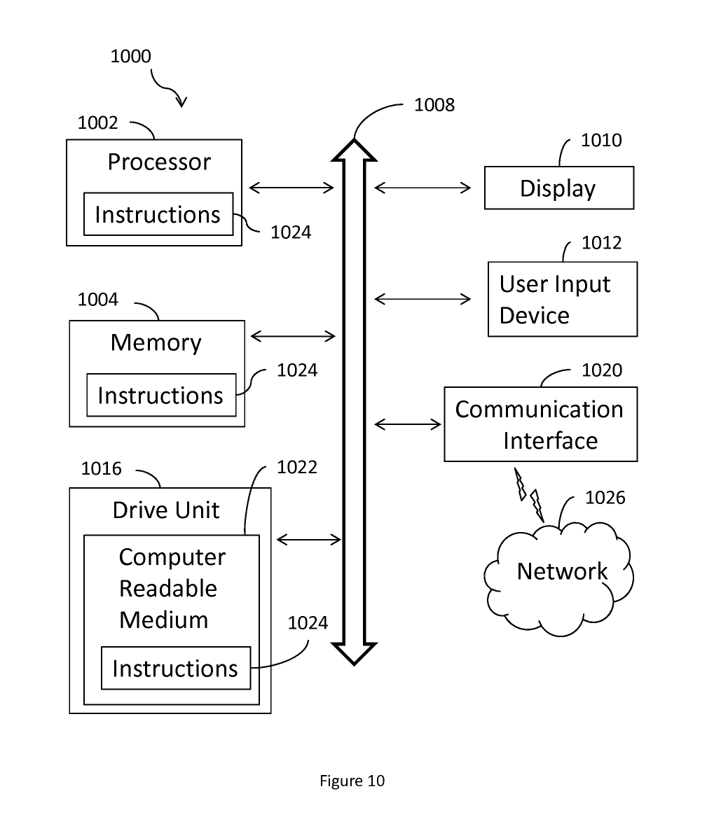

### DETAILED DESCRIPTION OF THE INVENTION

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e. contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

Disclosed herein are embodiments of a system, methods and algorithms for asset distribution. A glossary defining common terms is first provided.

Glossary

potentate: A sold software copy, licensed to a buyer, the software having cryptographic capabilities that are hidden with careful obfuscation, the software having policing capabilities including copyright and license enforcement, secure selling and authentication, and pervasive distribution capabilities including self duplication, self demonstration, self marketing with incentives, and self selling securely with multiple payment or free schemes.

potent: A copy of a potentate that hasn't been validated as a potentate yet by a sale.

scalar: As conventional in standard C, a scalar is a value of arithmetic or pointer type.

aggregate value: As conventional in standard C, an aggregate value is comprised of one or more scalars such as in an array, or struct.

digital asset: Software and/or digital data make up a digital asset. This includes software comprising potentates, potents, or authentication software therefor, inclusive of any data clubbed therewith.

object: As in standard C, an object comprises a storage area wherein data representing a scalar or aggregate value may be stored. An object storing an aggregate value may furthermore have the structure of an object as described in object-oriented programming, such as in C++.

Asset Distribution

Digital or binary content providers such as software makers and distributers, music providers, video providers, and document providers face two common problems. How to enforce copyright protection over their assets and how to profit and spread their assets far and wide throughout the globle. In this disclosure, we present a method of obtaining both simultaneously, harnessing the power of asset duplication (by anyone and everyone) to the benefit of legitimate content providers. The method, which endows a software asset with unmatched potency, to germinate legitimate assets for the content provider, briefly put loves repeated (duplication) encounters, each of which yields a new potent, dispersed asset that serves the content provider either as an immediate sale (thereafter named a potentate asset, or potentate in brief) or as a seed asset for a future sale (named a potent asset or potent in brief). Each encounter resulting in a potentate is screened by the content provider, to legitimize as a sale (generating a potentate) or not. An unlegitimized encounter (i.e. a duplication without sale), though not yielding a potentate, serves as a spare tire, as it can later generate sales for the content provider by its own legitimization (i.e. a purchase that is eventually carried out) or that of its copies, each of which counts as a potent till legitimized, if at all.

A distribution system for binary-encoded digital assets is disclosed. The system comprises a hiding means for hiding one or more keys or cryptography implementation in a digital asset. The system further comprises a copying means for asset distribution wherein a functionally-restricted asset copy is received for use or further distribution, directly or as a further copy, with or without access to a computer network. The system further comprises a self-policing means for enforcing asset safety, comprising an authentication means for an un-authenticated, digital asset wherein encrypted credentials data using one or more keys or cryptography implementation hidden in the asset are constructed for authentication by an authenticated digital asset or website. The self-policing means further comprises a secure selling means for an authenticated digital asset wherein either a sale transaction is carried out directly, securely, or the sale is delegated to a separate secure means, identifying the delegation by an encrypted identifier constructed using one or more keys or cryptography implementation hidden in the asset. The response from the secure means is decrypted using the one or more keys or cryptography implementation hidden in the asset to determine the success of the sale. The self-policing means further comprises a copyright and license enforcement means for an asset wherein encryption and decryption of computing context and other data using one or more keys or cryptography implementation hidden in the asset are carried out. Functionally-unrestricted asset use is permitted only after the asset has been sold and licensed to run in a recognizable computing context.

According to an embodiment, a digital asset comprises software.

According to another embodiment, the asset further comprises a combination of encrypted video, audio, or text data bundled with the software. The software is a software player to decrypt and play the data or encrypt and add data.

According to yet another embodiment, the bundled software thwarts simple data capture mechanisms comprising one or more of screen bitmap capture, screen text clip capture, screen text clipboard capture, or audio clip capture.

According to an embodiment, the hidden keys or cryptography implementation of the software comprises an expiry date or mechanism so that the software does not work after the date or mechanism disallows it.

According to another embodiment, the software enables a free or priced update with a continuing digital asset of different hidden keys or cryptography implementation, upon expiry of the software.

According to an embodiment, the update recurs with a well-announced expiry date for planning convenience.

According to an embodiment, the bundled data decrypted or encrypted by the hidden keys or cryptography implementation of the software player is reduced to a small partition so that the remaining one or more partitions may be bundled with one or more other software players, each distributed with its own distinct hidden keys or cryptography implementation.

According to an embodiment, the distribution system installs an authenticated digital asset on a machine where installed software consists of authenticated assets only.

According to another embodiment, the asset installation is mediated by a monitoring system on the machine.

According to yet another embodiment, the asset installation updates an expired or expiring asset with a successor asset of different hidden keys or cryptography implementation.

According to yet another embodiment, the update recurs with a well-announced expiry date for planning convenience.

According to an embodiment, the asset installation installs and periodically updates an authenticated browser.

According to an embodiment, the monitoring system disallows unmediated asset installation by resetting execution permission or disallowing a file with execute permission to run, or stopping a running software.

According to an embodiment, secure selling is carried out even on a machine with un-authenticated software.

According to an embodiment, no plaintext fragment of encrypted data is exposed to a user, other than possibly only sale-related input such as buyer details or payment details.

According to yet another embodiment, the computing context and other data are stored with the digital asset after sale and installation.

According to yet another embodiment, the credentials data constructed by a digital asset are passed to a browser to authenticate.

According to yet another embodiment, a key is stored in a digital asset by distribution into a subset of a large number of candidate data fields in the asset, the reconstruction of the key from the fields not being apparent from a reverse engineered control flow of the asset, forcing a combinatorially large number of key reconstructions to be considered in a key search making key discovery infeasible.

A distribution method for binary-encoded digital assets is disclosed. The method comprises a hiding step for hiding one or more keys or cryptography implementation in a digital asset. The method further comprises a copying step wherein a functionally-restricted asset copy is received for use or further distribution, directly or as a further copy, with or without access to a computer network. The method further comprises a self-policing step for enforcing asset safety, comprising an authentication step for an un-authenticated, digital asset wherein encrypted credentials data using one or more keys or cryptography implementation hidden in the asset are constructed for authentication by an authenticated digital asset or website. The self-policing step further comprises a secure selling step for an authenticated digital asset wherein either a sale transaction is carried out directly, securely, or the sale is delegated to a separate secure means, identifying the delegation by an encrypted identifier constructed using one or more keys or cryptography implementation hidden in the asset. The response from the secure means is decrypted using the one or more keys or cryptography implementation hidden in the asset to determine the success of the sale. The self-policing step further comprises a copyright and license enforcement step for an asset wherein encryption and decryption of computing context and other data using one or more keys or cryptography implementation hidden in the asset are carried out. Functionally-unrestricted asset use is permitted only after the asset has been sold and licensed to run in a recognizable computing context.

Since potent/potentate software can be duplicated and sold without an official distribution channel, the authenticity of a software being purchased need not always be known. It is important for a software to be able to present its credentials, to authenticate itself, for purposes such as ruling out fakes or trademark violators. By authenticating, a buyer is assured of immediate trademark compliance, that the software is genuine and not a fake. From a security perspective, another reason for software to be vetted as genuine potent/potentate is to rule out financial information sponging by a masquerader. An example of such sponging is masquerader software that indulges in credit card information grabbing without delivering the “sold” software.

Authentication, or the thwarting of masqueraders, can happily can be left to word of mouth often, on antecedent checking, as purchase should only be attempted when the entity is a duplicate of a known, working, potentate or stored spare only, or picked from a certified site, e.g. https://www.buffnstaff.com/downloads. In this approach, no extra baggage for security is required beyond the https protocol that is commonly available in browsers. The degree of freedom in this approach is maximum, but the burden placed on the buyer is enormous as he has to know the software being bought.

One security-protocol independent way to approximately authenticate an unknown software is to allow it to demonstrate some difficult, but marketwise narrow functionality that is beyond the reach of masqueraders and leaves the buyer enticed for the purchase. For example, a compiler product can say compile programs of size 199 characters exactly and show the working output to a user. This functionality is hard for a masquerader to implement without duplicating the provider's effort and does not turn the product into a free giveaway. The working demonstration is likely to be a selling advertisement for the product that a buyer can test to his comfort.

Another security-protocol independent authentication mechanism that can be offered is the provision of hash codes for a legitimate duplicate that can be independently verified by a user. The ability to carry this out without being networked maximizes the degree of freedom of the buyer. The hash function has to be widely available, e.g. compute file size, compute compressed file size, and the answer for the software has to be widely published and stable so that the user can be expected to have cached or online access to it. Examples of generic software that can be used to compute the hash code are Is-I (in Unix), that yields the code size. Another code is a compressed code size, that may be obtained using common, specific packages like zip. Other hash codes are tests for a specific pattern in the code binary or a checksum etc. To cross check, the published hash codes have to be available widely. The source of the wide availability has to be secure, coming from an https website or a verified asset or an advertisement slogan so that masquerading is either not possible or is catchable. The advertisement slogan can well be the version name for the product, which can comprise the hash code itself. Hash codes can be computed as a part of a formal authentication function for an asset.

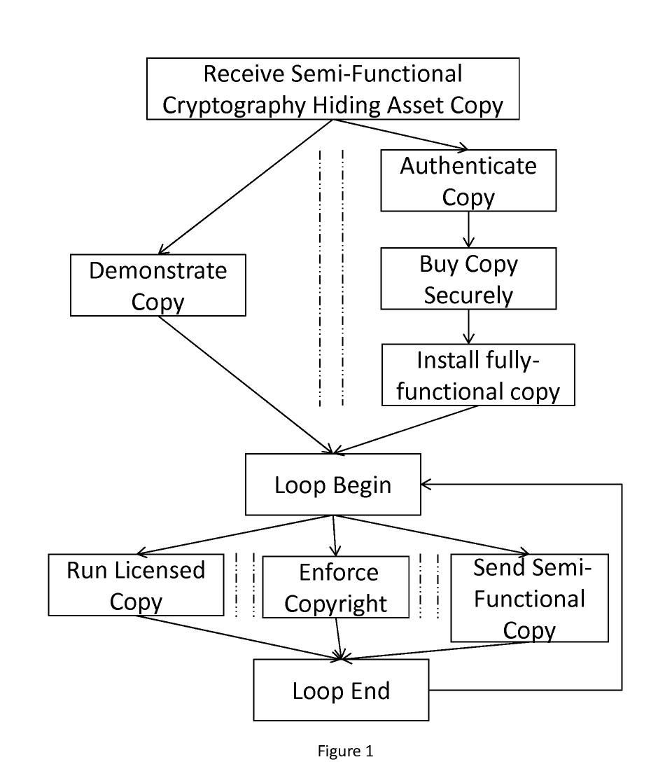

FIG. 1 contains a flowchart illustrating the working of the potentate asset distribution system. Using techniques discussed later, a potentate is constructed with a hidden cryptography function, hiding keys, data and implementation details from the prying eyes of an adversary who may wish to reverse engineer or discover these details by scrutinizing the object code or binaries comprising the potentate or running them. The sub system or method comprising these techniques is used once during potentate construction, after which, the distribution system only executes the steps shown in FIG. 1. In a first step, a potentate is received as a potent, which is a semi-functional cryptography hiding asset copy, for further processing. The potent is then run in a demonstration mode, showcasing marketing features of the asset, to convince the user of the purchase value of the asset. The user is shown only the functionality of interest to the user. Enough computation is packed in the demonstration mode to obfuscate the cryptography function of the potent, by interleaving the two computations, as required by the cryptography hiding system. The cryptography function is used by the authentication, purchase, and installation steps, which are carried out logically in parallel with the interleaved demonstration code. As much of the cryptography function for these steps is carried out in advance, in parallel with the demonstration code, as possible, to maximize the interleaved overlap and obfuscation. The parallelism may be only logical, using single-threaded interleaving of the demonstration and cryptography code, but it can also be physically parallel, with the cryptography code pieces running in parallel with the larger demonstration code, at random triggering points in the demonstration code.

In the authentication function, the potent computes an encrypted credentials file for the potent, for authentication by a trusted party (software asset and/or secure website). In a buying step, a user may purchase an authenticated asset, by either carrying out the encoded e-commerce sales steps contained in the potent directly (e.g. transact using credit card information), or the purchase may be delegated to some other secure means for purchase, e.g. a physical cheque mailed to the potent manufacturer, with an encrypted transaction identifier generated for the delegated transaction. The secure means is expected to return its answer (successful sale or not) by a return, encrypted identifier, which when fed back to the potent results in acceptance of the fact. In case of the delegated means, the potent running blocks till the sale answer is obtained from the secure means. Such a potent stores this state in an encrypted file called a paint file, for continuation later. The potent can be run in demonstration mode till the sale transaction completes.

Since the sale delegation step above does not ask for or put a buyer's confidential financial information at risk, the sale delegation step does not require a formally authenticated potent to be carried out. So for instance, a buyer convinced by the demonstration mode, or knowledgeable of the potent's antecedents, or its hash codes etc. may purchase the potent using the delegated sales mechanism securely.

Upon a successful completion of a sale transaction, the potent saves a snapshot of the computing environment that the potent has been licensed to run in. The snapshot or context comprises some identifying information pertaining to the computing environment so that in later runs, the environment can be verified to be the same so that copyright on the potent can be enforced and the potent allowed to run only on the recognized machine. The sale and context details are saved in encrypted state in the paint file, as a part of installation of the potent as a potentate (i.e. a sold and licensed software). Till installation as a potentate, the potent is a functionally restricted software, capable only of running in demonstration mode and not full function mode. The full function mode becomes available only after sale and installation. The details saved in the paint file are also communicated in encrypted state to the content provider (potent manufacturer), so that the provider has complete knowledge of the sale and license context.

Up till this step, the potent runs in logically parallel mode, with a restricted demonstration mode running in parallel with the other steps. The parallel mode is shown by the dotted parallel lines in-between the demonstration and authentication/buy/install steps in the flowchart of FIG. 1. After installation, the potentate runs in another logically parallel mode, as shown in the loop of FIG. 1. The loop illustrates the sequence of fully functional potentate runs that may be made in the licensed computing environment, by a user. Each run of the potentate, transpires in parallel with the other steps shown in the loop using parallel dotted lines. One step, with cryptography function is the enforce copyright step, wherein the encrypted context in a paint file is decrypted and compared with the actual entities in the computing environment for a match. The copyright check is made dispersed over each potentate run, blocking the potentate in the unexpected case that it fails. This case is not illustrated in the figure. In this case, after a dialog with the user, the potentate either resumes running with copyright verified and paint modified, or the potentate relapses to the semi-functional potent mode and jumps back to the first step in the flowchart. Details of the dialog are discussed later in this disclosure.

In concurrence with the copyright enforcement step, the user can ask the potentate to make its own copy for further distribution to other buyers with the user playing the role of a seller intermediary. In this step, a copy of the potentate is made along with a stripped down paint file, identifying the user's potentate as the parent of the new potent. This identification helps the user get reward credits for a sale from the content provider. The potent software bundle is made available at the file location provided by the user. The user is of course free to make a copy of the potentate, manually, himself, outside of the loop shown in FIG. 1, but then he may not get the stripped down paint file, unless he is able to put together the same from some other copying transaction.

If the antecedents of a software are unknown and the approximate methods above do not satisfy a buyer, then the buyer can formally authenticate the software using the method taught herein. In this method, the buyer runs the software by providing arguments that induce the software to present its credentials. The credentials file is an encrypted file that is passed as is to an authentication software that after a dialogue with the potent, either passes the file (verifying the software as genuine), or rejects it (the software is a fake), or states the software is out-of-date. An out-of-date software is recommended to not be used, unless the buyer is sure for some other reason. The out-of-date software finding also arranges for a computer update that deletes the dated software and replaces it with an up-to-date software from the content provider. The authentication software is lightweight software that can be downloaded from the secure, https, content provider website and freely duplicated itself. It also presents its own credentials for authentication by authentication software like itself. Authentication software, when downloaded, comes with an expiry date so that it is updated automatically with a fresh version when the expiry occurs. Softwares (authentication, potents, and potentates) are tied to expiry dates so that the cryptographic protocols followed by them are time bound and changed regularly, bounding the time window within which an adversary has to try to break them in case of an attack. In the rare case of a successful attack, the content provider at its discretion can also push or notify fresh updates to all known buyers and software keepers so that the software in use is safe.

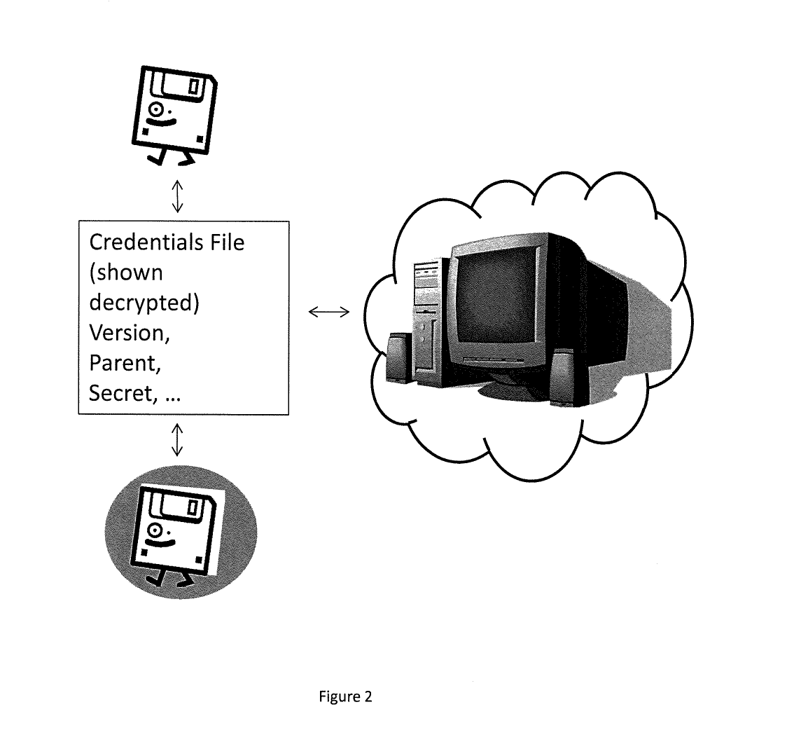

FIG. 2 illustrates the steps taken in authenticating a potent or potentate. The floppy disk icon with legs in the figure represents a running program (e.g. potent or potentate). The program creates a credentials file that is passed to either another running program that is already pre-authenticated (hence shown in a haloed, grey circle) or passed to a secure website (shown in a network cloud) to authenticate. The contents of the credentials file are encrypted for security. FIG. 2 shows the decrypted fields of the file for convenience. One field is the version number of the encrypting program. A second field is the parent identification of the program (the software from which the program was copied), so the origin of the program can be traced. A secret is passed between a potent and an authenticator also, but not in the initial credentials file. There may be other optional fields in the credentials file, which are indicated by the ellipsis ( . . . ) and left unspecified in FIG. 2.

After a credentials file has been decrypted by the authenticator, the authenticator inserts a secret in the file, re-encrypts it and sends the file back to the potent/potentate. The encryption process may well permute the field bytes, so the encrypted file may not look like a (secret) suffix appended to the original credentials file. Upon decrypting the returned credentials file, the potent computes a hash function on the received input and sends this hash value in place of the secret, in a re-encrypted credentials file back to the authenticator. The authenticator decrypts the file, checks the hash value and declares the potent authenticated, if the results match the authenticator's own computation of the hash value. FIG. 2 shows the two-way communication between the potent/potentate and authenticator using the credentials format.

Authentication software, since it is content provider (and therefore content) specific, can also compute focused hash codes that routine software like Is -I discussed previously cannot. At the content provider's discretion, hash code checking can also be provided by authentication software as a part of its offering. Indeed, the hash code computation provides the non-cryptography code (analogous to demonstration code in FIG. 1), that is interleaved with the cryptography computation of the authenticator for obfuscation.

Note that authentication software may be treated exactly as another digital asset to be sold. The pricing is of course the seller's prerogative. The authentication software may be functionally restricted by not giving the user all hash results unless it has been purchased and installed.

Only after a potent has been authenticated formally by an authenticator, may a buyer attempt a purchase through the potent's own sale mechanism. A purchase attempt, without authentication, is totally the buyer's own prerogative and risk. The financial information provided by a buyer to an unauthenticated, potent masquerader may result in theft of the buyer's data by the masquerader. Hence, direct purchases without authentication are highly disparaged.

An alternative that reduces the need for software authentication somewhat is to separate the payment from the sale. In this case, a transaction id is generated by the software to carry out a sale, to be used in making the payment separately from the rest of the sale. The software begins to run in a limited manner after the sale is initiated (e.g. for a week), awaiting the sale transaction to be completed. To complete the sale transaction, the buyer can log in to a https payment gateway website and provide the transaction id and pay for the sale obtaining a sale id that can be fed back to the software enabling it completely. Otherwise, the user can pay by offline methods such as sending a cheque with the transaction id to the content provider physical address, or make a cash payment to a content provider counter for the purpose, etc. Each of these methods returns the sale id to be fed back to the software. The authentication and/or redressal in these methods is by direct contact with the channel chosen for payment, with https being certified and the others being physically available. Although the need for authentication is ameliorated by such an approach, it is not fully eliminated as a masquerader can well indulge in credit card information sponging under false pretexts to hoodwink a buyer, who in good intention is likely to be keen enough to part with the information. Hence reliance on authenticated software is highly desirable from all perspectives.

A combination of the above methods for authentication/antecedent checking reduces the degree of freedom of a masquerader to beat the security checks that he might be able to do in isolation. The combination then suffices to establish the antecedents of all products.

With key and cryptography hiding described as above, antecedent checking can be promoted with incentives as follows: a sale that can track its source (e.g. the parent asset's purchaser or the content provider's website) informs the content provider of the parent so that the parent's purchaser is paid an incentive for promoting the sale. If the parent cannot be tracked, or the parent is the content provider's website, then the incentive returns to the provider. Tracking a source is possible if all the user-visible asset files in the parent's environment are copied in the preceding duplication(s) so that they are available for the sale process. Like Amway's seller incentivisation, the entire chain of parents can be paid incentives for a sale. In contrast to the Amway model, the characteristics of the sale here differ as follows:

1. No inventory and no intermediary need be present in the sale. The purchaser has to have or make a copy of the parent's visible files. Whether this occurs by direct access to the parent's computer, or by asynchronous communication like e-mail, or through intermediaries e.g. the parent purchaser's friend, is immaterial. If the non-executable visible files are lost in the process, at most the incentive to the parent chain is lost, not the legitimacy of the sale itself, recording an overall win for the content provider. Thus the path of the sale including any intermediary people or computers is neither tracked nor auditable. The end result is whether the user has the goods or not. In this scenario, it is possible for the goods to be altered en-route (e.g. executables from one parent, other visible files from another), but this at most directs the incentive credit away from one parent to another. Whether or why this happens is immaterial to the content provider, who pays the incentive solely to chain of parents found in the files with which the sale is carried out.

2. Regardless of the path of sales, at most one chain of parents has to be paid the incentive money, keeping the reimbursement process straightforward. This is established by the theorem below.

Theorem 1. The ancestors identified in a sale consist of a chain of potentates, linked to each other in a line by the parent relation

Proof. By Induction over the set of parent chains available with the content provider for sales.

Base Case. First sale. Clearly this occurs from the content provider, through its web site or parent identification as the content provider. Thus this sale adds one empty chain for this sale to the empty set of parent chains available with the content provider.

N^{th} sale. Assume that with this sale, all the parents information available with the content provider consists of linear potentate chains alone.

N+1^{th} sale. With this sale, if a parent is not identified, then an empty chain gets added for the sale with the content provider. If a parent is identified, then, that parent's chain available with the content provider gets increased by the parent itself linearly as the parent chain for the sale. Thus after the sale, the parent information available with the content provider comprises linear parent chains alone and the chain identified for the sale is a linear chain in itself. QED.

The theorem provided above is for the purpose of explaining the working of the mechanism taught by the present disclosure.

As mentioned above, the path of a sale from a parent is not tracked. Hence it is possible for the parenting credit to be shifted around, changing the parent chain for a sale. It is imperative therefore that the incentives passed from the content provider to a parent chain be impervious to such changes, else the content provider can end up paying extra in incentives. For example, suppose the incentive is a fixed payment per chain member. It is then in the interest of the sale intermediaries to mis-identify a long chain with the sale to maximize payment from the content provider. One easy mechanism to fix such liability is to have say fixed payment per chain, so that a longer chain is not in the interest of the intermediaries. This still does not guarantee that the chain will not be swapped, but it contains the financial liability of the content provider. It is up to the content provider to decide what ratios to use in dividing the fixed incentive within the parent chain. It is also up to the content provider whether to make the incentive scheme time or season dependent, to reduce the net outflow of money for the incentives. For example, the content provider can choose to payout only for sales made during holidays, or an academic term (defined appropriately).

Once a buyer concludes a payment interaction with a running potent, the potent becomes a potentate and vulnerable to sale repudiation by the buyer (e.g. buyer claims purchase was spurious and wants money back from say a credit card company while holding on to the running potentate). To counter such a scenario, a potentate logs the usage of the buyer after purchase. Once a minimum threshold of use is logged, the potentate disallows further use of itself till it can communicate the above threshold use to the provider over a network. A provider then handles a sale repudiation as follows: for the buyer, if the provider finds minimum threshold use communication from the potentate, then the repudiation is contested with the evidence. If the communication has not reached the provider, then the provider accepts the repudiation and flags the same in its database. If and when a minimum threshold communication for the buyer reaches the provider, the flag in the database leads to a communication back to the potentate that no further use of the software is to be permitted to the buyer. The potentate then acquires the state of a potent.

Once a buyer concludes a payment interaction resulting in a potentate, the potentate tries to communicate the sale and installation information to the provider at the earliest opportunity that the network is available to it. If the network does not become available till the repudiation threshold is crossed, then the potentate blocks running till the threshold, sale and installation information have been communicated back to the provider using the network.

Licensing Capability

According to yet another embodiment, the computing context and other data are stored with the digital asset after sale and installation.

A computing context storing system is disclosed. A computing context comprises a narrow time window within which the computing context is stored in the computing environment.

According to an embodiment, narrow time windows or exact times of creation or modification of one or more files or folders along with their locations in a computing environment further comprise the computing context.

According to another embodiment, the partial content of one or more files or folders along with their locations in a computing environment further comprise the computing context.

According to yet another embodiment, the names of one or more files or folders along with their locations in a computing environment further comprise the computing context.

According to yet another embodiment, functional data related to the accurate working of the computing environment further comprises the computing context.

A computing context recognition system for handling and recognizing a changing computing context is disclosed. The system stores a computing context to re-construct the computing context from the stored data later. The later context is recognized to be that of the same computing environment for which the context was stored, if the reconstructed context matches a freshly computed context for more than a preset, passing number of stored context entities.

According to an embodiment, after a computing context is recognized, a revised computing context is stored in place of the earlier stored computing context, for more accurate recognition of a computing context later.

A computing context storing method is disclosed. The method comprises a step of storing a computing context within a narrow time window part of the computing context.

A computing context recognition method is disclosed. The method comprises a step of storing a computing context. The method further comprises a step of re-constructing the computing context from the stored data later, recognizing the later context to be that of the same computing environment for which the context was stored, if the reconstructed context matches a freshly computed context for more than a preset, passing number of stored context entities.

Prevalent licensing mechanisms query a user computer for information like serial number to manage licensing. Such licensing can be undermined if the user environment is altered to return false answers for the questions such as another computer's serial number. In order to overcome such masquerading attacks, the mechanism we propose here additionally alters the user machine minimally (e.g. by saving the machine's unique characteristics, a fingerprint, in an encrypted file), so that the modification made marks or paints the machine in a manner that only the licensing mechanism can recognize. This scheme by itself is vulnerable if the machine's characteristics change, so that the licensing system is tempted to consider itself in a foreign machine environment and disallow the software to run. The mechanism proposed here overcomes this weakness by incorporating a multitude of expendable modifications within its encrypted paint file so that the loss of a few does not compromise recognition, so long as a threshold of recognizable modifications survive. Further, the modifications or paint marks are made to evolve and grow over time to overcome inadvertent losses, so the licensing repairs temporary losses when they occur. Finally, the paint evolution also migrates the paint file from its initial content (at sale time) so that the paint file becomes variable and distant from the configuration at sale time which is what is typically the target of a piracy attack. Key to the robustness against masquerade attacks is the identification of machine characteristics to create paint marks using base, most common operating system primitives that are unlikely to be substituted by masquerade functions without crippling the machine. A library call to obtain the machine serial number may be masqueraded, without affecting overall system functionality. Basic file operations, on the other hand may not, as their substitution is likely to cripple the machine.

In a first step, the computer of the user is queried to determine stable information specific to itself, that is unlikely to be the same in a different computer. This information may be considered as random answer data for a question, that is likely to differ from computer to computer if the question is so posed to a multitude. Examples of such information are: computer name, computer serial number, computer model number, the value of the PATH variable defined in the software environment, details of the processor used by the computer, details of the random access memory (RAM) used by the computer, details of the internal hard disk used by the computer etc. This step is well discussed in prior art and any of the prevalent techniques may be used to carry out the step in software.

In a generalization of the first step, multiple independent questions are asked of the user computer so that the likelihood of the combined sequence of answers for the first step being identical for a different computer decreases as a product of the individual probabilities. In other words, if the probability of identical answers for k questions for two computers is p₁, p₂, . . . pₖ for the k questions, then the combined probability of the k independent questions is p₁*p₂* . . . *pₖ for the k questions.

Note that any of the combined or single answers to the questions of the first step are of relatively stable information, which a pirate may be familiar with. So long as substituting an actual answer to a question does not functionally affect the machine or cripple it, a pirate may try to substitute the answer with a masqueraded one in an attempt to hijack the installation process. If changing an answer requires tinkering with a machine and changing its functionality, a pirate may not attempt it in order to avoid detection or to avoid crippling the machine. The machine serial number is an example of a non-functional question that can be masqueraded easily. It is important that at least some questions asked of the computer environment exercise its functional aspects so as to avoid being vulnerable to a masquerade attack.

For licensing, each time potentate runs, it queries the computer with the question set described above, and running the software only if the answers match the answers obtained at the time of sale and installation. If some of the answers have changed, such as name of computer, or installed RAM, then the system goes into an updation mode, where it asks guarded questions for acquiring stable answers. For example, it presents a standard, exemplary menu of possibly changed items and asks the user to identify any changed entities and their earlier values. The user is asked to go beyond the example values to seek coverage. The changed set can be entered cumulatively in more than one identification session.

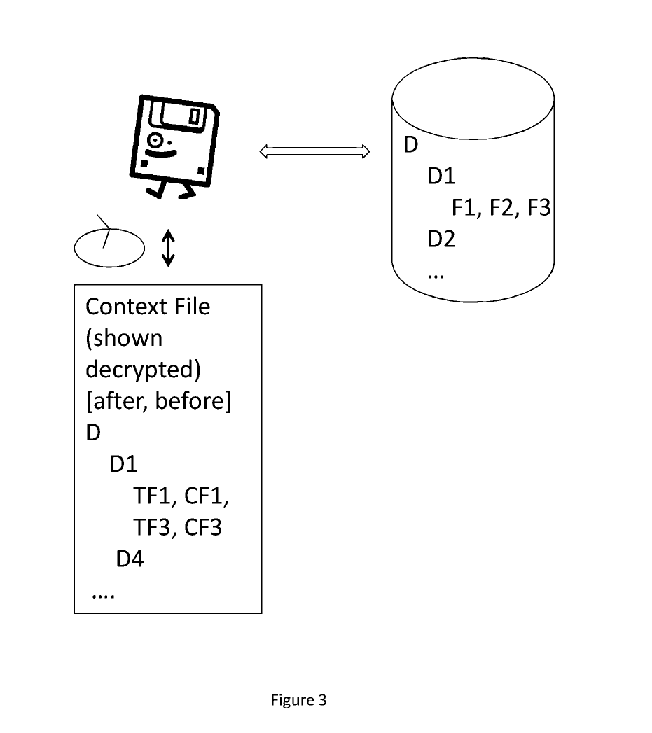

FIG. 3 illustrates the saving of a context file by a potent/potentate (potentate/potent shown as a floppy disk icon with legs). The context file stores encrypted data, which is shown un-encrypted in the figure for convenience. The running software both reads and writes the context file, keeping it evolving as the computer environment itself evolves over time. This allows the context file to more closely track the environment for accurate recognition through the life of the software. The loop below the potentate icon reflects this constant evolution in the content of the context file.

An example of functional questions that may be asked of a computer are narrow time windows in which specific, stable files have been installed on the computer. The paint file itself is an example of a file installed on the computer. When the paint file is created in the installation process, the creating program, using time functions can estimate the creation time of the install file and enter the window, encrypted properly in the paint file itself prior to closing the final file. If the paint file is copied and installed on another machine in a piracy attempt, the file creation time on that machine is unlikely to match the encrypted window time. Further, the creation and modification times of other stable files on the filesystem can be saved in the paint window, making it highly unlikely that another computer will have the same files, file locations and file times matching this computer. File creation and modification time windows, specialized to zero-width windows often, reflecting exact times, are thus a difficult functional, computer identifying question for a pirate to masquerade. Even if the clock is altered in a piracy attempt of copying a file at a desired time, it is hard to manage to copy distinct creation time and modification time, as no modification of the encrypted file can be entertained as it will break on decryption. So the modification has to be a forward and backward modification with a total null effect and timed to fit the modification window after creation window, which is hard to do, even with a controlled clock. In the limit, it can be assumed that the time attributes of file inodes in an adversarial system can be subverted in a copying attempt. By storing time windows of multiple, unknown files, the information being stored in an encrypted state in the paint file, an adversary cannot be expected to duplicate the exact combination of windows stored for the original computer, thereby disabling any piracy attempt.

The context file in FIG. 3 shows the storing of a subset of the directory hierarchy on disk into the context file. The disk memory drum shows subdirectories D1, D2 and so on for the directory D of which only D1 and D4 are reflected in the context snapshot. The context contains the window of its own creation time in the [after, before] range. The times for files F1 and F3 are saved under directory D1, leaving aside file F2 for example. Further context data for the files e.g. their partial contents, is stored as CF1 and CF3.

Another example of a functional question is the content of specific files on the computer. It is preferable to query long-lived (e.g. old) files, which given their history or knowledge are unlikely to change much. The starting line, or some line at some specific offset in the files can be queried and the content encrypted in the paint file. Such a paint mark is unlikely to repeated in other computers at the same location in the filesystems.

Another example of a functional question is a partial snapshot of a stable part of the file hierarchy in the filesystem on a computer. Again, a computer's filesystem is unlikely to be repeated identically elsewhere.

While such functional questions may be stable, they may evolve gradually over time, sometimes even rapidly. Such changes have to be handled by the licensing system which is described next.

For gradual changes, the paint file can be updated and a new window saved for the paint file itself, when a change is detected. So long as only a minor change occurs, the licensing system remains capable of recognizing the computer environment and the minor change only triggers an evolutionary change in the paint file to track the computer evolution. If the change is drastic, the licensing system has to enter into a dialogue with the user to ascertain the reason for the substantive change in its stable information as discussed previously. The dialogue, for a file system drastic change, can reach a resolution like, hard disk failure, resulting in a new hard disk. Such a failure can be corroborated further by non-functional queries such as hard disk identity, or a combination of functional queries that corroborate each other like file hierarchy has changed, along with time windows, along with file contents. In conjunction with server updates, discussed later, such tracking can allow the licensing system to continue with drastic changes in its stable set also.

The evolutionary nature of the paint file can lead to continual narrowing of the time windows for specific files, to the betterment of the overall information. This can be carried out in each evolutionary step, by predicting a tight window to modify the paint file within, and storing the window in the file. The evolutionary nature of the paint file additionally makes it hard for an adversary to discover the exact set of time windows stored for specific files in the paint file, hardening any attempt of software piracy.

During sale and installation, communication with a content provider server is carried out to inform it of the sale and paint details. The server is kept informed of paint evolution so that even if the user inadvertently un-installs the software, he can re-synch with the server to re-install it and continue as is. The communication with the server serves another purpose. If an adversary carries out a piracy attempt successfully, then the adversary still has to keep the server informed of its paint details. In synchronizing paint, the server also checks its sale credentials and if it finds more than one track of paint evolution reporting the same sale details, it can shut one or both tracks down as a redundant failure containment mechanism.

The server interaction as described above can also be skipped for specific sales at a calculated risk for the content provider. This risk may be taken for fast, un-tracked software propagation. The sale part of the interaction may then be comprised of the following:

An onsite sale, carried out by a sales person with no server connection. The sales person is responsible for the receipt generation if any, money collection if any, and later server updation if any. The sales person has to feed an encrypted authorization to the potent during sale interaction allowing the sale to succeed. The authorization also tells the potentate whether it will carry out server interaction post the sale or not.

Sale by coupons, wherein a coupon is an encrypted authorization for a granted sale during a specific time window, e.g. a day of sale. To be doubly sure, the potent has to verify the time from the local clock with a global network time before allowing the sale to succeed. Examples of such sales include:

Free giveaways: The giveaway may be an authorization for life of the potentate, or for a specific period or number of uses, whereafter the potentate becomes a potent again. The giveaway period, e.g. for needy students, may promote sales indirectly by building up a user base.

Deferred sales: A deferred sale allows a potentate to be generated, with money collection, either discounted or complete, occurring later after a certain period or number of uses.

Multimedia and Text Sales

According to another embodiment, the asset further comprises a combination of encrypted video, audio, or text data bundled with the software. The software is a software player to decrypt and play the data or encrypt and add data.

According to yet another embodiment, the bundled software thwarts simple data capture mechanisms comprising one or more of screen bitmap capture, screen text clip capture, screen text clipboard capture, or audio clip capture.

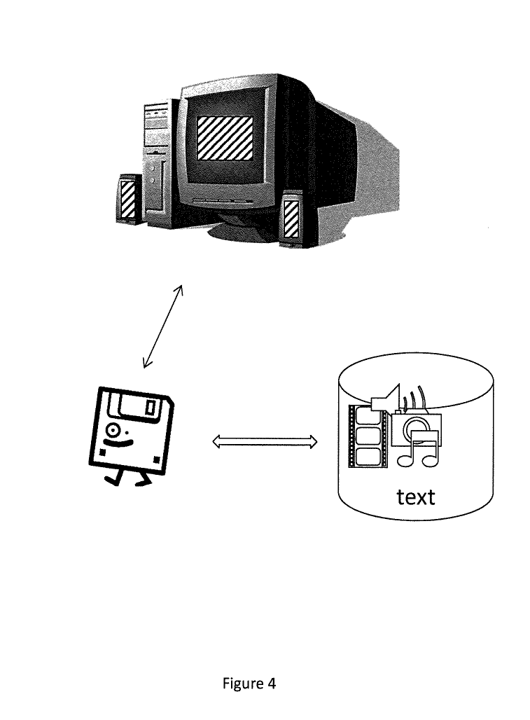

FIG. 4 illustrates potents and potentates for selling copyright protected multimedia and text data. As the figure shows, the data can comprise any combination of audio, video, still image (e.g. photographs) and text data that can be rendered by a software player. As shown in the figure, the screen to display the data and the speakers to play the data are carefully pre-empted (discussed below) to prevent data capture by the rendering devices. The data itself is encrypted and either bundled with the software player or delivered to an installed player. The player itself is a potent or potentate. The player is capable of decrypting the data to play it. It can also add new data to the bundle by accepting contributions from the user and saving them after encryption. The contribution may optionally also be forwarded to the content provider, depending on the service provided.

Multimedia sales may be routed through the software selling mechanism discussed thus far. This comprises encrypted provision of the multimedia data and a soft player optionally, in case the encrypted data cannot be played on the client side without the soft player. The soft player preferably has the following characteristics: for video or visual data, it disables bitmap capture so the copyrighted data cannot be conveniently copied by anyone. This may be carried out as follows: An event listener is registered for the display window, that (a) resets the clipboard so any prior event's capture is overwritten (b) repaints the screen with the window region whitened so that a future event capture is overruled. Further, the listener can create an artificial event so that the sequence above is repeated overwriting any bitmap saved by a process prior to the overwriting of the clipboard above.

Text sales can be carried out similarly. In the case of text, a text displayer may be provided that besides disabling bitmap captures, also disables the text clipboard for the window. Thus edit events over the window are disallowed.

Analogous to bitmap capture, audio capture by the hardware player (speakers) can be disabled to prevent copyright violation.

Once a data/text player has been installed, additional data can be streamed to the player as and when needed in the encrypted format. Hardware for the soft players can well comprise embedded software players.

Notes

The mechanism provided thus far can support computer upgrades as follows. A user is allowed to un-install the software from a machine obtaining a free credit for a fresh purchase. The free credit is used then to install for free on a new machine.

Portability of a software on multiple machines and platforms is an unknown often, with the buyer unsure if the purchased software will run fully on the platform he buys it for. This difficulty can be addressed as follows. The demonstration capability of a potent can be designed to exercise all core functionality of the software, such as file opening/closing, display etc. and the demo itself turned into a verification of portability of the potent. After a free demo, a user can confidently make a purchase, knowing that the software will spring no surprises thereafter.

Instead of providing authentication software for downloads on the content provider website, the website can alternatively upload the credentials file provided by a potent/potentate to the content provider website for verification online. This mechanism bypasses the need for authentication software upgrades, but requires online access for any authentication.

According to yet another embodiment, the credentials data constructed by a digital asset are passed to a browser to authenticate.

As an alternate to providing authentication software to users, a potentate or potent can instead support security-protocol-based authentication measures as found in website authentication. So for instance, the potent when run in authentication mode on a client machine can communicate with the client's browser instead to return validation information associated with a https page reserved by the content provider for the purpose. This mode has to be run with networking disabled with the potentate/potent software verifying that, and the security protocol and communication being carried out locally on the client machine itself, allowing the browser to authenticate the software, just as a website is authenticated. The key advantage of this approach is that it allows widespread browser software with https support to be leveraged for authenticating potent/potentate software without distributing any new authentication software for the purpose. This mechanism however requires cooperation from browser vendors and can work only if the straightforward functionality is provided in available browsers.

Since the potent/potentate software is likely to undergo examination in binary form by pirates in an effort to decipher the public key and private keys embedded in it (to break the authentication protocol), it is imperative that the software hide the keys and key handling mechanisms well to resist such investigations. These methods are discussed in the teaching provided herein.

For browser-supported authentication, the page pointed to in authentication is changed (along with its public and private keys) if a potent's keys are compromised. The current page of authentication is well advertised. A potent with compromised keys remains stuck on the old page and can be detected. Potents are periodically required to synchronize and upgrade themselves with the content provider server to be up to date with the current keys. If a potent is unable to authenticate using the latest page, the potent is not considered authentic by this mechanism. The user can persist if he has other knowledge of the particular potent, such as specific antecedent knowledge. The change of pages in this scheme is expected to be infrequent, so the scheme can work well with infrequent synchronizations. The content provider needs to broadcast changes if they occur widely, to prevent fraud, which can well be done by e-mailing the current user base, especially those who are known to be affected and sending them an update of the software with un-compromised keys. The public key change does not need to be broadcast specifically by the content provider. The new key is obtained normally by the browser by its own standard mechanism.

For potents authenticated by non-browser, normal authentication software if the authentication agent is coded with the public key of the content provider, the agent still goes out of date if the key expires or its private counterpart (key) is busted. The agent has to periodically update its public keys or itself—both are equivalent. Public keys in authentication software do not require special hiding, since they are pubic data. Only private keys require special handling and hiding, since they are the target that adversaries try to discover.

According to yet another embodiment, a key is stored in a digital asset by distribution into a subset of a large number of candidate data fields in the asset, the reconstruction of the key from the fields not being apparent from a reverse engineered control flow of the asset, forcing a combinatorially large number of key reconstructions to be considered in a key search making key discovery infeasible.

The private keys, or symmetric encryption keys embedded in potent/potentates and authentication softwares have to be hidden very carefully. A data structure for key hiding in a binary software image, distributed freely is as follows. This comprises a K-nested encryption: There are K keys in arbitrary positions in the binary image. Using the first key, the second key is decrypted, using the second, the third, and so on till the last and the last one is used to decrypt the private key. In a binary image with N key candidates, N>K, this gives NK permutations to try out for finding the private key, which, for large N and K is infeasible to discover. The permutation is now the real key, and is hidden by designating up some bits of each of the keys as the next key offset (modulo N). The bits can well point to the same key repeatedly and hence no consistency check can be carried out by the adversary in ruling out infeasible key sequences. The N candidates are themselves random bits. Now the pointer to the first key and the choice of the bitmap defining the next key field is the real key. The bit map has 2^{M}−1 alternatives, where M is the key size in bits. For a large M, this key is infeasible to break. The way to get a large M is to permit appended/overlapped readings of the N key fields. The bitmap can be generated dynamically and not be available in the control flow of the program to reverse engineer.

Cryptography Obfuscation

For authenticating and for other purposes discussed above, the system encrypts and decrypts data, for which it works with a key hidden within the system. The key need not be hidden, in case it is a public key of asymmetric cryptography, but then, the private key with its partner, say the authentication software, still has to be hidden. As discussed later, the system needs to both encrypt and decrypt data that has to be kept secret from the client running the system. Hence the use of a public key for both these purposes is not sufficient as the client will also be able to decrypt the secret data then. The system is thus faced with a need to hide a private key, while running in a client environment. With key hiding a need, the system can as well work with symmetric encryption and hide the relevant key. Symmetric encryption is faster and far simpler than public-key infrastructure, so the option to work solely with symmetric encryption is a valuable advantage the system then offers.

A cryptography hiding system for hiding one or more keys or cryptography implementation in a binary-encoded digital asset using holistic, efficient steganography is disclosed. The system comprises an interleaving means for sequentially or concurrently interleaving the computation of non-cryptography, useful code with cryptography code. The system further comprises an obfuscating memory management means for creating an encoded pointer representation of a scalar, comprising one or more encoded pointers pointing to one or more objects created and managed by the memory management means for maintaining the scalar in an obfuscated state throughout the lifetime of the scalar. The system further comprises a class obfuscation means for translating a class to one or more data structures or procedures. The system further comprises a procedure obfuscation means for de-stacking one or more parameters of a procedure or translating a procedure call to jumps to and from an inlined procedure body.

A cryptography hiding system for hiding one or more keys or cryptography implementation in a binary-encoded digital asset using holistic, efficient steganography is disclosed. The system comprises an interleaving loop or recursive procedure instantiating one or more re-entrant calls to one or more procedures or macros in cryptography code, such that one or more re-entrant calls to one or more procedures or macros in useful, non-cryptography code are interspersed in-between any two cryptography code calls. A cryptography call typically comprises a smaller stateful computation than a larger stateful computation comprised by a non-cryptography call.

According to an embodiment, the interleaving loop or recursive procedure is parallelized to execute a cryptography call largely in parallel with non-cryptography computation.

A cryptography hiding method for hiding one or more keys or cryptography implementation in a binary-encoded digital asset using holistic, efficient steganography is disclosed. The method comprises an interleaving step for interleaving sequentially or concurrently, the computation of non-cryptography, useful code with cryptography code. The method further comprises an obfuscating memory management step for creating an encoded pointer representation of a scalar, comprising the use of one or more encoded pointers pointing to one or more objects created and managed for maintaining the scalar in an obfuscated state. The method further comprises a class obfuscation step for translating a class to one or more data structures or procedures. The method further comprises a procedure obfuscation step for de-stacking one or more parameters of a procedure or translating a procedure call to jumps to and from an inlined procedure body.

A cryptography hiding method for hiding one or more keys or cryptography implementation in a binary-encoded digital asset using holistic, efficient steganography is disclosed. The method comprises the step of using an interleaving loop or recursive procedure for instantiating one or more re-entrant calls to one or more procedures or macros in cryptography code, such that one or more re-entrant calls to one or more procedures or macros in useful, non-cryptography code are interspersed in-between any two cryptography code calls. A cryptography call typically comprises a smaller stateful computation than a larger stateful computation comprised by a non-cryptography call.

To hide a key and related cryptographic mechanism, the system implements a source-to-source transformation. The transformation carries out efficient, holistic steganography that systematically inflates cryptographic code computation with regular application computation, thereby hiding the cryptographic computation by burying it in non-cryptographic, regular application computation. The cryptographic computation and also parts of the application computation are systematically obfuscated to make the hiding all the more effective. The cryptographic code is automatically generated (post transformation) and inserted as a part of the application code, so it cannot be discerned separately from the application code, as say a separate dynamically linked library (DLL).

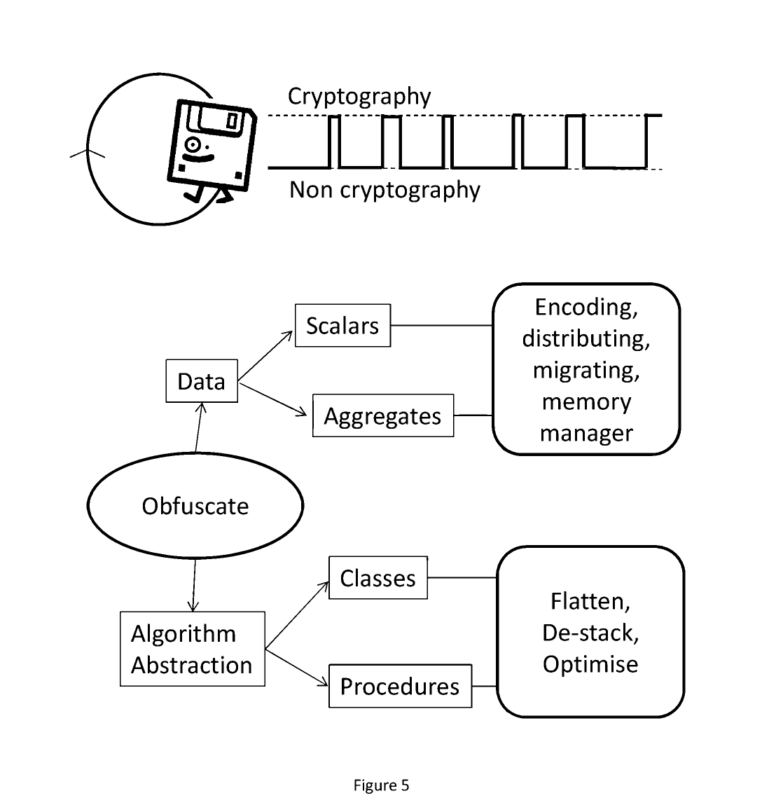

FIG. 5 illustrates a potent icon running in a loop or recursion, shown as a circle that the icon runs around in. The loop/recursion repeatedly executes cryptography code followed by non cryptography or application code, such as demonstration code, so that the work graph of the potent shows continuous toggling between the two kinds of work as shown on the right side of the icon. Typically, larger amount of non cryptography code is executed at a time compared to cryptography code, so that a steganography is obtained wherein the cryptography computation is hidden by burial in the non cryptography computation. The work graph is like that of a digital clock, generally asymmetric, context switching stealthily between the two kinds of code.

Within the cryptography code, and to some extent in the non cryptography code, deliberate obfuscation is carried out to hide the cryptography implementation and to do it stealthily, so that an adversary cannot figure out where obfuscation begins and ends. Programs have two major abstraction mechanisms, namely data and algorithms, both of which are obfuscated effectively and efficiently, as shown in the figure. Data comprises both scalar and aggregate types and both are obfuscated using a novel memory manager dedicated to the purpose. The memory manager encodes all data using pointers, which are known to make up intractable obfuscation, in a pluggable manner, so that an adversary has no means to model or reverse engineer the obfuscation. Static analysis is intractable, and observation of dynamic running is so tediously difficult and hidden with markers erased that figuring out the structure of the cryptography manually or semi-automatically is impractical. The memory manager uses pointers to allocated memory objects, with garbage collection optionally aiding the memory manager, so that migration of the objects changes data encodings transparently, making the obfuscation a moving target. Similarly, data is distributed all over the allocated objects randomly, and objects themselves are randomly placed over the heap, so that high entropy of obfuscation is attained.

For algorithm obfuscation the primary target is the procedure abstraction of programming languages. Since procedures are underpinned by stacks, the stack mechanism is obfuscated by optimization, attaining high efficiency. Targeting the stack undermines stack based run-time observation and debugging tools, hardening the task of an adversary. Furthermore, static analysis is undermined, leaving an adversary little or no room to maneuver in. Parameter passing over the stack is flattened by the use of global variables, arrays, and procedure calls rescheduled and streamlined to enable this effort. The class abstraction is flattened away into procedures and (aggregate) objects as a part of compilation to de-structure the program.

The cryptographic computation is interleaved in application computation as follows:

First, the cryptographic computation is invoked as a sequence of re-entrant procedure or macro calls, wherein a macro call comprises running a statically expanded macro code. These calls are interspersed in regular application code computation. A main loop in the application code can call the call the cryptographic invocations, using a random number generator to decide the intervening application computation size between two cryptographic calls. The first call to the cryptographic code itself may happen after some relatively long period of application computation to hide the start. Thereafter, the interspersed cryptographic sequence runs. The last call informs the main loop that no further cryptographic calls are to be made and the application runs un-interrupted thereafter.

The notion of re-entrant code here is not stateless. The code is stateful and makes progress from call to call. It is not stateless as in re-entrant libraries in prior art. Our prior work on compiler frontends, Indian patent application 1025/DEL/2014, provides an example of parallel stage codes that make progress from call to call. The stages make progress, interleaved with each other, either as a sequential interleaving, or as explicitly parallel code, with the progress occurring from call to call over the input text being lexed and parsed. Similarly, the progress in the interleaving of application code and cryptographic code comprises progress of the cryptographic code over the data being encrypted or decrypted. The application makes its own independent progress over its own input. The two progresses are made interleaved with each other, either as a sequential interleaving, or as explicitly parallel stages. For explicitly parallel stages, the (short) stage calls to the cryptographic code may complete well ahead of their spacing in the main loop, resulting in well-spaced parallel computations of the cryptographic code. If the application code computes speculatively, the spaced cryptographic calls may be well hidden as routine parallel computation.

The cryptographic code is preferable callable with multiple entry points, with any schedule among the entry points being followed by the main loop in the application code. So for example, with cryptography entry points, A( ), B( ), and C( ), and application entry point, X( ), a round robin sequential schedule in the main loop calls the entries in the order: A( ), X( ), B( ), X( ), C( ), X( ), A( ), X( ), B( ), X( ), C( ), X( ), A( ), X( ) . . . Preferably, there would be multiple entry points for the application code also, which themselves would be scheduled similarly, statically, or dynamically.

The cryptographic code is best obfuscated as discussed below. Preferably, the code preceding and succeeding the cryptography code and random portions of the application code are also obfuscated code for the purpose of steganography.

For a source language like C++, a first step in obfuscation is to flatten its classes away. In other words, the C++ program is translated to a program within its C subset, with classes replaced by structs, arrays, unions and procedures. This step is well known in prior art and is one of the standard paths of compiling C++ programs. For example, the EDG frontend (www.edg.com) supports an IL-lowering step in which such source-to-source transformation is carried out.

The major program abstraction in programming languages comprises procedures and procedure calls, which if obfuscated, lead to a very difficult to understand program. Provided here are several novel methods of optimizing a program such that the resulting program may perform better and also be harder to understand.

A procedure obfuscation system for de-stacking one or more procedure parameters is disclosed. The system comprises a static analyzer means capable of guidance by one or more user annotations and a source-to-source transformer means capable of replacing a reference to a procedure parameter with a non-stack reference.

According to an embodiment, the user annotations comprise sharpening a symbolic value of a variable, location or expression to a subset of a symbolic value generated by a static analyzer.

According to another embodiment, the non-stack reference comprises a global variable.

According to yet another embodiment, the static analyzer means comprises a means for determining that a procedure call has no nested calls to the procedure.

According to yet another embodiment, the static analyzer means further comprises a means for determining that the number of nested procedure calls to a procedure contained within a call to the same procedure is less than a statically-known constant. The non-stack reference further comprises a global array variable indexed at a nesting depth of a procedure call.

According to yet another embodiment, the static analyzer means further comprises a means for determining that barring procedure return values, all dependencies within a procedure are intra-procedural. The source-to-source transformer means comprises a means for replacing a procedure with a parameter memoising procedure.

A procedure obfuscation method for de-stacking one or more procedure parameters is disclosed. The method comprises a static analysis step guided by one or more user annotations, and a source-to-source transformation step replacing a reference to a procedure parameter with a non-stack reference.

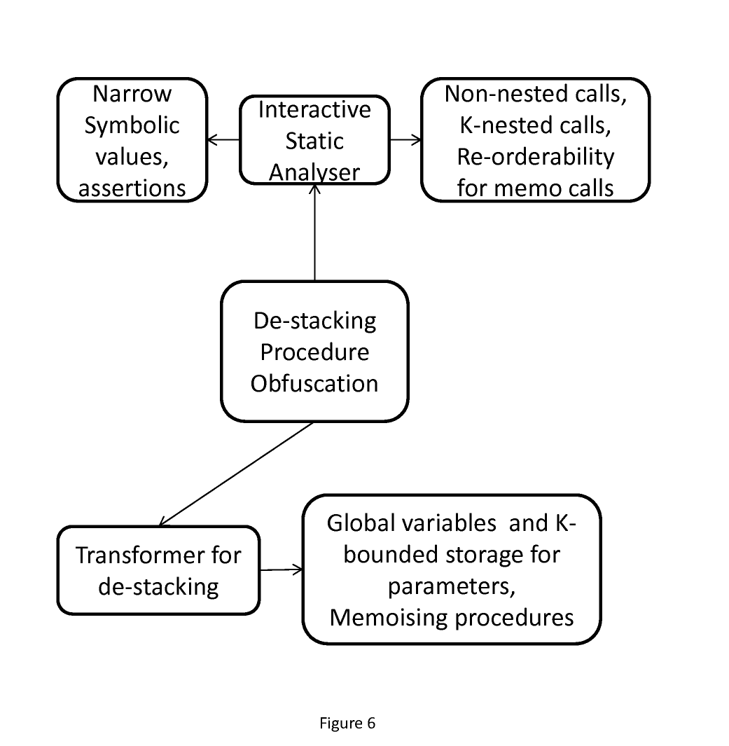

FIG. 6 illustrates the means of procedure obfuscation by de-stacking parameters. It comprises a static analyzer that takes user input in its work by annotations or equivalently, interactively. Furthermore, the method comprises a source-to-source transformer for transforming the input program. The transformer is oriented towards destacking parameters and is capable of transforming a parameter reference in a procedure with a non parameter reference such as a global variable. Since a parameter is carried on the stack, this comprises replacing a stack reference to a non stack reference.

The static analyzer analyses procedures as to whether a procedure call can generate nested calls to the same procedure. A procedure may be found to generate no nested calls, or nested calls that are a constant K bounded, i.e. the depth of nesting of calls to the same procedure may not exceed the static constant K. Procedures are also analyzed for conversion into cached or memoised functions and whether the memoised computation of a procedure can be rescheduled to reduce the extent of use of stack whereby the stack can be bypassed completely. The annotations or user input taken by the analyzer may comprise assertions in the program, for example narrowing the symbolic values for variables and expressions constructed by the static analyzer. For example, a predicate in a conditional may be narrowed to true or false, allowing the conditional to be treated as one branch only. The unfolding of a loop may be narrowed to exactly n unfoldings, where n may be a constant or a symbol. Besides symbol narrowings, the user may provide information such as an assertion that a procedure is non nesting, etc.

Using the conclusions drawn by the static analyzer, the transformer replaces parameter references in a procedure with other references. Besides global variables, the references may comprise array indexes, e.g. X[i], or array of frames references, where the array element is a struct or frame and after indexing the array for a frame, a particular member of the frame is dereferenced. Memoising procedures may be scheduled as desired by an iterative loop, wherein the order of iteration dictates the order in which the memoised procedure is called over its parameter space or domain.

Consider first a procedure for which a simple static analysis establishes that the procedure does not have nested calls to itself, viz. in no execution path of the procedure, a call to the same procedure occurs. In such a case, it is clear that the arguments to the procedure can be de-stacked, viz. they need not be stored on the stack and can be stored in global variables instead. This is because at any time, there is at most only one live instantiation of the procedure. The global variables holding the arguments are in effect registers storing the procedure parameters.

Consider next a procedure, for which a static analysis establishes that the procedure is constant nested, viz., nested calls to the procedure are at most a constant k deep. In this case, the procedure parameters can again be de-stacked and stored in a global frame[k] array, wherein each frame stores the parameters for one particular call. Each call can track its frame position by a global depth counter, that is incremented each time the procedure body for a call is entered and decremented each time the body is exited. The counter in effect tracks the dynamic schedule of nested procedure calls. The reference to an individual parameter, X, is replaced by frame[c]→X in the procedure body, with c being the counter value.

The static analysis to discover the above cases is a straightforward path analysis informed by the reachability of procedures to the call points encountered. The Pundit, a symbolic execution analyzer in Pradeep Varma, “Compile-time analyses and run-time support for a higher-order, distributed data structures-based parallel language”, PhD Thesis, Yale University, Department of Computer Science, University Microfilms International, Ann Arbor, Michigan, 1995, is suitable for such a path analysis. Since the problem in general is undecidable, the static analysis may be sharpened with annotations as follows. The static analysis only proceeds over annotated code (e.g. annotated function bodies), looking for procedure calls. Such annotation may be carried out as command line arguments, e.g. identifying the procedures to be analyzed, or such details in a compilation-profile file provided as a command-line argument. Annotation is a useful method because not all the application program needs to be analyzed and the cryptographic code may be small enough for a focused annotated analysis to be carried out. For procedures not found to have de-stackable arguments, the analyzer can point out the reasons for not de-stacking, such as a nested call with a function pointer that may alias to the procedure being de-stacked. The user can then assert to the analyzer whether the function pointer indeed aliases as such or not and the analyzer proceed with the sharpened information.

For determining k-depth-bounded nested calls, it is necessary to prune the recursing path from the function entry to the function call. An annotation to the effect that the nested call is k-bounded is sufficient to bound such a path. Further annotations can then specify the boolean values the conditionals along the path can acquire symbolically, allowing the analyzer to have complete knowledge of the nested computation for the procedure. This is sufficient to optimize the procedure call by de-stacking its arguments.

A third method for de-stacking parameters covers the last case, of recursive procedure calls as follows: The unbounded loop between a procedure entry and its nested, recursive call is pruned and the boolean predicates along the path specified symbolically so that the recursive invocations of the one or more procedures along the path are labelled symbolically. Such specification occurs by annotation or interactive dialog between the user and the analyzer so that symbolic values in individual variable bindings are sharpened. Sharpening may comprise pruning a symbolic value to a more specified range or reducing the symbolic values that may bind to a particular variable. For example, as discussed above, a boolean predicate may be specified to evaluate to only true for k instantiations, which is an assertion or annotation to the effect that the predicate value falls in the range {true} alone and not {true, false}. An assignment using a conditional expression that yields a NULL pointer along one path and a data structure pointer along another may ordinarily set a variable to either of the two symbolic values. On specific annotation, one of the settings may be pruned, as specified by the user.

With recursive unfoldings of a function or set of mutually recursive functions explained by annotation and/or static analysis as above, the analyzer can further analyses whether all the data dependencies within a procedure invocation are intra-procedural or not (barring answers returned by calls). If they are intra-procedural, then the procedure invocations may be re-ordered vis-a-vis each other so long as the return value of an invocation is made available to a dependent procedure body for its computation. Thus a schedule of procedure unfoldings (viz. a procedure invocation, minus a recursive call contained within it) may be followed that sequentially computes the recursive computation, while following an order that is not necessarily the same as defined in the recursive computation. For example consider the fibonacci function:

fib(0)=0;

fib(1)=1;

fib(n)=fib(n−1)+fib(n−2);

A recursive computation of fib(10) yields a tree of recursive fibonacci calls that can instead be re-scheduled as fib(0), fib(1), fib(2), fib(3) . . . unfoldings that compute fib(10) in a bottom-up schedule. This is because the unfoldings have intra-procedural dependencies only. With the result of fib(m) cached and made available to a fib(m+1) and fib(m+2) unfolding, the recursive computation can be computed in a sequence. By using cached implementation of fib(n) and specifying a schedule of computation, namely the order n, for fib(n) calls, the entire fib(n) computation can be replaced by n fib unfoldings exactly. As discussed in John Hughes, “Lazy memo-functions”, in Proceedings of a conference on Functional Programming Languages and Computer Architecture, Jean-Pierre Jouannaud (Ed.), Springer-Verlag New York, Incorporated, New York, N.Y., USA, isbn: 3-387-15975-4, pages 129-146, and its successor work, Pradeep Varma and Paul Hudak, “Memo-functions in ALFL”, YALEU/DCS/RR759, Research Report, Department of Computer Science, Yale University, December 1989, a cached function is computed on a set of arguments only once; later calls on the same arguments reuse the result of the first call, which is cached in some memoising cache for the purpose. In the context of fib(n), the parameters for the fib unfoldings need not be carried on stack, since only one fib unfolding is active at one time. Hence the parameter n can be a global variable with the stack completely bypassed. To specify a schedule for computing cached recursive calls, an iterative loop is sufficient, e.g. for (i=0; i<=n; i++) global parameter=i; fib( ). The later computations of fib use the cached answers of earlier fib calls. This scheme differs from cached or memo functions in prior art in that de-stacking or obfuscating parameters is not a subject of the prior scheme; hence the necessary static analysis and re-ordered scheduling of procedures are not discussed either.

Thus recursive procedure calls can have their parameters de-stacked as discussed above. Given that both recursive and non-recursive procedure calls may have their parameters de-stacked, the use of the stack to understand program behavior is highly curtailed by the optimized and efficient methods discussed here. The methods presented here are likely to be highly effective and efficient, as they eliminate waste computation (e.g. unstacking operations, redundant recursive calls) while obfuscating the procedural abstraction.

Additional obfuscation of the procedural abstraction, that composes well with the obfuscation methods discussed above comprises replacing a call with a goto in a source-to-source transformed program. First, from prior art, it is known that a procedure call can well be inlined, by replacing the call with the body of the procedure after appropriate variable renaming. Inlining code has the problem of code bloat, so for efficiency reasons, the method preferred herein uses a novel method of instantiating the procedure body only once per calling procedure body at most. If the body of a procedure Y has N calls to procedure X, the body of X is inlined only once in the body of Y with gotos reusing the one inlined body as follows. The entry to X's inlined body in Y has a jump label for its entry. At the end of the inlined body, a switch is used to jump from the exit to the continuations of its calling points. Each calling point jumps to the inlined body after setting the switching variable, so that the exit switch will jump back to the continuation of the calling point after computing the inlined call to X. While the gotos manage the proper control flow of the procedure calls, the parameter passing can be done using the de-stacking techniques discussed above so that no stack operations or jsr (jump to subroutine) operations need to be invoked at the binary compiled version of the code. This makes the procedure calls invisible to an adversary having access only to the object code.

One call to X in the body of Y can be the position at which X's body is inlined. The other calls re-use this inlined body by the use of jumps. Alternatively, the inlined body of X can be positioned at a place in Y's body that is not visited by any path from the entry of Y. For example, it can be after a return statement. All uses of such an X body occur by the use of gotos.

A major obfuscation step comprises replacing scalar quantities in a program by encoded equivalents. The encoding is novel in utilizing a set of pointers to encode any scalar type. The encoding is highly general, as the pointers can point to and use any data or table in the machine or be amenable to pointer arithmetic to translate themselves into the ordinary value for a scalar type. So for example, a long type, of 32 bits may be represented by 4 pointers, one per byte, with the encoded value, being not amenable to algebraic manipulation and being amenable only to a machine-dependent interpretation, wherein the pointers are used to possibly read the machine memory to resolve to the long value that is encoded by them. In other words, the novel encoding for scalars is highly obfuscated and difficult to analyze for an adversary.

An obfuscating memory management system for creating an encoded pointer representation of a scalar is disclosed. The system comprises one or more encoding pointers pointing to one or more objects created and managed by the memory management system for maintaining the scalar in an obfuscated state throughout the lifetime of the scalar.

According to an embodiment, the objects are laid out randomly over the heap memory.

According to another embodiment, an encoding pointer is used only once in encoding a scalar part.

According to yet another embodiment, an object comprises one or more fields containing one or more pointers to one or more allocated objects. The value denoted by an encoding pointer can be obtained by dynamic computation comprising the use of a combination of the object, one or more of the pointers, one or more of other pointers to the allocated objects, and the allocated objects.

According to yet another embodiment, the one or more pointers to allocated objects contained in fields of the object further denote a value of a reference count for an encoding pointer. The value can be obtained by dynamic computation comprising the use of a combination of the object, one or more of the pointers, one or more of other pointers to the allocated objects, and the allocated objects.

According to yet another embodiment, the memory management system increments the reference count upon dynamically finding a scalar part's encoding pointer using a filter function.

According to yet another embodiment, the memory management system reclaims the object upon reference count elimination.

According to yet another embodiment, the memory management system reclaims or migrates one or more of the object or allocated objects using garbage collection.

According to yet another embodiment, the memory management system never stores a scalar or scalar part directly in memory.

According to yet another embodiment, the memory management system scalarizes the scalar into independent encoding pointers.

According to yet another embodiment, the memory management system distributes an aggregate object's scalars' encoding pointers all over the object.

According to yet another embodiment, the memory management system distributes a set of aggregate objects' scalars' encoding pointers all over the objects.

According to yet another embodiment, the memory management system further re-distributes the encoding pointers in the set of aggregate objects, upon increase or decrease of objects in the set due to allocation or de-allocation.

According to yet another embodiment, the memory management system defers an object de-allocation till a further re-distribution vacates the de-allocated object prior to the de-allocation.

According to yet another embodiment, the memory management system initializes the scalar using dynamic computation comprising the use of a set of literals excluding the literal initializing the scalar in un-obfuscated program code.

According to yet another embodiment, an object comprises one or more fields denoting a value for an encoding pointer or reference count. The value can be obtained by dynamic computation comprising the use of the object.

According to yet another embodiment, the encoded pointer representation of the scalar is changed when one or more objects pointed to by one or more encoding pointers are migrated by garbage collection. The scalar's value denotation remains unchanged.

An obfuscating memory management method for creating an encoded pointer representation of a scalar is disclosed. The method comprises the step of using one or more encoding pointers pointing to one or more objects created and managed for maintaining the scalar in an obfuscated state throughout the lifetime of the scalar.

An obfuscating memory management system is disclosed. The system allocates or de-allocates an object with meta-data comprising object size or layout. The contents of the object may be obfuscated by distribution or re-distribution, part by part, anywhere over the object or one or more other objects.

According to an embodiment, the memory management system defers an object's deallocation till occupants of the object in lieu of parts distributed or re-distributed to other objects have been vacated.

According to another embodiment, an object is allocated with larger storage than its meta-data size, so that false scalars or duplicated parts may be used to fill the extra space for further obfuscation.

According to an embodiment the memory management system comprises a garbage collector.

According to another embodiment, the garbage collector uses the layout metadata to identify or de-obfuscate pointer scalars in the object.

According to an embodiment, the memory management system scalarizes the object's parts in substitution for object allocation on the stack. The object's encoding pointers are independently stored.

According to another embodiment, the memory management system enables part-by-part scalarization of all stack-allocated variables of a procedure. The variables are shifted to heap allocation only if the variables comprise a pointer scalar.

According to an embodiment, the object meta-data itself is obfuscated.

An obfuscating memory management method is disclosed. The method comprising the step of allocating or de-allocating an object with meta-data comprising object size or layout such that the contents of the object may be obfuscated by distribution or re-distribution, part by part, anywhere over the object or one or more other objects.

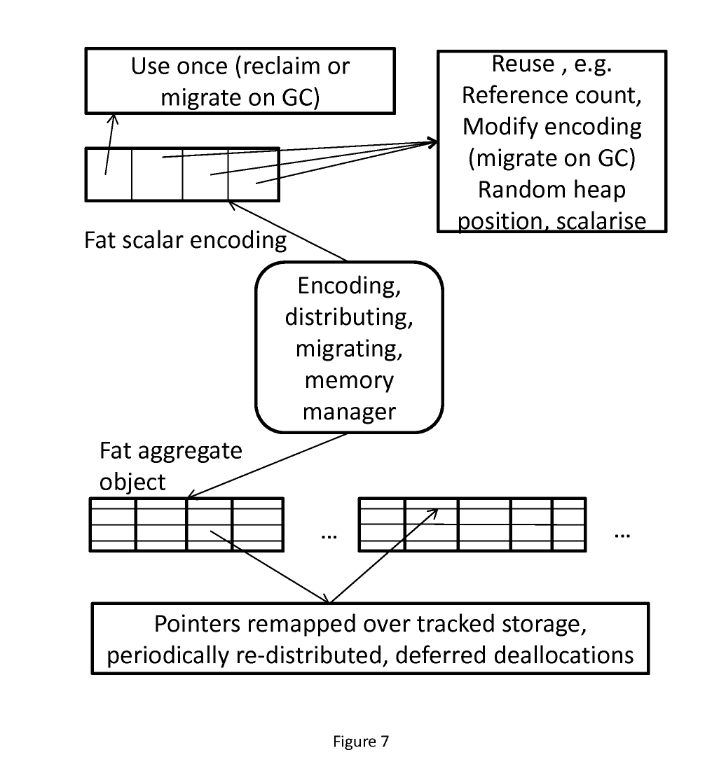

FIG. 7 illustrates the novel memory manager contributed by our work for obfuscating program data. The manager uses pointers to encode a scalar or aggregate object. A scalar, comprising one or more bytes is divided into parts each of which is substituted by an encoding pointer. So a character scalar, for instance, comprising one byte, may become two parts, both of which are substituted by a pointer apiece. An ordinary scalar ends up becoming a fat scalar, of a different size, as a result of the transformation. An aggregate object, comprising one or more scalar or other aggregate objects is transformed similarly, byte by byte or part by part, into a fat aggregate object. The figure illustrates a fat scalar as a sequence of slots, each of which is filled by an encoding pointer. A fat aggregate object is shown as a vertical sequence of horizontally slotted fat scalars, each slot in a fat scalar being filled by the encoding pointer for the slot. The memory manager is capable of creating encoding pointers pointing to objects created by the memory manager. The memory manager may distribute or scalarize the encoding pointers of a scalar or aggregate object randomly over the storage space for the object, in an order that differs from any ordinary storage sequence of the parts. Using garbage collection, for example a recently disclosed, novel, pathbreaking true garbage collector for C/C++ and other languages in 1013/DEL/2013 (PCT/IB2014/060291), and 2713/DEL/2012 (PCT/IB2013/056856), the memory manager may migrate or relocate the allocated objects repeatedly, updating the pointers accordingly thereby making the pointer encodings dynamic and a difficult, moving target for an adversary.

Two options are shown in FIG. 7 for the encoding pointers of a fat scalar. Three encoding pointers are shown to point to the same object, reusing the same pointer encoding for the three parts of the scalar. The object pointed to is a box highlighting the features of such pointer reuse—that reference counts may be used to track the extent of reuse, the shared pointer may be positioned randomly over the heap, and migrated variously e.g. upon GC. The pointers for a fat scalar may be scalarized into a set of encoding pointers, each located independently or separately of the others. For scalarisation done on a stack frame, for local variables, the independent or separated encoding pointers for all the stack scalars are placed randomly on the frame's stack storage. For scalarisation done by shifting a stack frame to the heap, the independent or separated encoding pointers are distributed randomly on the heap storage for the frame. One slot of the fat scalar is shown pointing to a box highlighting a one-time use of a pointer, analogous to the one-time pad encryption. The pointer is not reused and may be reclaimed upon GC or modified if the pointed object is migrated. The pointer may also be randomly positioned over the heap, like reused pointers, and may undergo scalarisation along with its peers for a fat scalar.

The fat aggregate object in FIG. 7 illustrates one of its encoding pointers, according to its part's storage location, re-mapped to a different storage location in a different fat aggregate object. This re-mapping occurs by a random re-distribution of the encoding pointers all over the storage space for the (one or more) aggregate objects. Two fat aggregate objects are shown out of a sequence, with the remapping shown for one pointer in the left object remapped to a different slot in the right object. The pointer itself may be one-use or a reusable pointer, details of which are not shown. The re-distribution of encoding pointers, all over the storage of an aggregate object(s), may be repeatedly changed, periodically. The re-distribution may involve storage space of just one aggregate object, or more than one aggregate object, all considered together. The set of aggregate objects may change dynamically, upon allocation and de-allocation. A de-allocation may have to be deferred, in order to vacate its storage of encoding pointers of other objects, prior to de-allocating the object.

In the technique to represent scalars presented herein, a scalar type, represented as a fat scalar, comprising a set of pointers that encode the scalar type, is preferably scalarised and distributed over the machine memory so that its component pointers are not even localised in the neighborhood of each other. Further, by encoding every scalar in such pointer encoding, it is never the case that the machine memory (run-time program image) contains a snapshot of any data field as is within itself. So no data field can be read off the machine memory directly, or by permutation, in the present scheme. This is a major invariant provided by the present system.

The representation of data (scalars), thus, is provided by a novel obfuscating memory manager provided by the present system. The memory manager is capable of working with an existing garbage collection system, e.g. as disclosed in Indian patent numbers 1013/DEL/2013 (PCT/IB2014/060291), and 2713/DEL/2012 (PCT/IB2013/056856), whose one or two-word encoded pointers can substitute for the ordinary pointers discussed herein straightforwardly.

In a first step for turning ordinary scalars into fat scalars, the scalar types are first identified in the program. This may be done by annotation, as only the cryptographic code and an application subset is to be obfuscated thus. The cryptographic code may be kept in a dedicated set of file(s) for the purpose and identification of the file(s) suffices for annotation.

Next, each scalar type is replaced by a struct comprising the fat scalar. Although this description is provided in the context of C, similar operations may be carried out in the context of other languages. Following the struct conversion, assignments of scalar values are changed to assignments of pointer members of the struct, the pointers representing encoding of the scalar value. Note that by this conversion, each scalar type requires the storage that is pointer aligned and sized a multiple of a pointer type. Since a pointer type is typically a word (double word also, in 1013/DEL/2013 (PCT/IB2014/060291), and 2713/DEL/2012 (PCT/IB2013/056856)), mostly, padding space in objects disappears and most or all memory stores useful data.

Similarly, scalar type reads are replaced by struct copying operations from a source to destination variable, unless the scalar type is to be used, in which case, in which case, the pointers may be read and decoded to regenerate the scalar value, which is used immediately, so that the reconstructed value is not stored in memory at all. At most, temporary variables may store the value in the compiled code, which generally are register allocated.

Initialization of a scalar field may be done using arithmetic generation of the parts encoded by individual pointers that encode the scalar. The arithmetically generated parts are encoded into the encoding pointers using macros or functions for the same. By using arithmetic to generate the parts, none of the used literals correspond to literals in the original program, so the symbol table does not contain literals that give away the initialization values of individual fields. For example, suppose an integer field has to be initialized with 513 and is encoded as four pointers, one for each byte. Then the parts to be encoded are 0, 0, 2, 1 for the four pointers, representing the 0 for the most significant byte and 1 for the least significant. These parts can be generated by arithmetic such as 25−(13+12), 13+13−26, 32/16, 13−12. None of the literals stored in the symbol table have any correspondence with the actual numbers. The choice of the literals to be stored in the symbol table can be randomly generated to maximize entropy or obfuscation. The arithmetic can be hidden within a long path of computation, involving say function calls, for the same obfuscator purpose.

Cryptography key, string and character data/literals can be initialized as above, character by character, or byte by byte. In this case, a byte can be broken into two quartets apiece, of 4 bits each, to obfuscate individual character data.

The details of the run-time system to support pointer encodings are as follows. First, the encoding from a scalar to its parts is specified. This may be as simple as partitioning the bits/bytes as in the example above. Next, the one-to-many or one-to-one mapping from a part to an encoding pointer is NON EXPLICITLY specified. Using the example above and a one-to-one mapping, this maps each byte value to a specific pointer. A reverse mapping function, from a pointer back to a part also has to be specified, for which many options are possible. A first option is to have the reverse mapping available by dereferencing the pointer, in which case, the storage pointed to by the pointers make up a lookup table for the reverse mapping. The storage can well comprise one struct per pointer, for which each struct can be allocated dynamically (malloc-ed) upon need. Indeed, the table can be populated apriori, randomizing the order in which the structs are allocated from the heap. This randomizes the table layout also. The memory manager can allocate the structs with intervening jumps, distributing the random table over the heap. The space in-between the structs can be managed by the memory manager automatically. For example, in the context of the garbage collecting memory manager of 1013/DEL/2013 (PCT/IB2014/060291), and 2713/DEL/2012 (PCT/IB2013/056856), the extended gaps can be updated, after each struct allocation to free up a (smaller) extended gap up to the next struct to be allocated, so that the space in-between is not wasted and captured in the extended gaps of 1013/DEL/2013 (PCT/IB2014/060291), and 2713/DEL/2012 (PCT/IB2013/056856). Further, another datum can be stored adjacent to the part value in each struct comprising the number of references to the struct using an encoding pointer. This can be used to implement a reference counting mechanism for the encoding pointer, so that after a threshold of use, the struct can be abandoned, so that the encoding mechanism is not overused enough to become recognizable by an adversary. The reference counting mechanism easily increments a count whenever a scalar part is translated to an encoding value. The count is harder to decrement though, without the services of a garbage collector, but it can be done occasionally, for example when a local variable exits its scope, so long as the encoding pointer has not escaped.

This option of pointer dereferencing for reverse encoding, described above, is quite capable, but suffers from storing parts as is in memory for inspection by an adversary. This may suffice, since a scalar is not stored as a whole but rather in parts. Another mechanism carries out pointer arithmetic on the dereferenced value for the purpose of the reverse mapping. For example, the a base pointer can be stored, the difference of which versus a dereferenced pointer value decides the part value. If the base pointer is the NULL pointer, then the absolute value of the dereferenced pointer decides the part value. Specific bits of the pointer may be used to decide the part value, for example the lowest byte, or the second byte. Combined with a non-NULL base pointer, this yields a part value that is not directly stored in the memory reached through an encoding pointer.

The reference counting mechanism can be encoded in the remaining bits of an dereferenced pointer above. So for instance, if the second lowest byte stores the pointer part, the lowest byte can store the reference count. This scheme has the advantage that an encoding dereferenced value, a pointer, constantly changes, making the encoding dereferenced value itself a moving target, with the encoding pointer becoming a stateful entity.

It is desirable to keep the dereferenced pointers live, viz. pointing to allocated memory, in order to add stealth or disguise to the scheme. The memory manager is aware of the allocated memory and can choose a specific base pointer and dereferenced pointer implementation that keeps all pointers in an allocated region. For example, if 64 kilobytes of contiguous space has been allocated, the region can be traversed using 16 bits or 2 bytes total. If such space has not been allocated, it can be allocated in anticipation by the memory manager for use later. Since the starting address may not fall on a 16-bit boundary, the addressing of the region may spill over to an adjacent 16-bit region, requiring at most one more bit to address into the region. Using these 2 bytes+1 bit, all pointers to the region may be used as dereferenced pointers. Alternatively, and preferably, although not aligned on a 16-bit boundary, the region will occupy half or a majority of one 16-bit aligned space and the pointers in a that subset alone may be used to decode a part. This subset may be addressed using 16 bits alone. Of this subset, only half of a 16-bit region needs to be addressed, requiring a total of 15 bits. Since these 15-bits represent a 15-bit aligned region, the bits have free rein and may acquire any value. Of these 15 bits, a byte is needed to encode a byte part, leaving the rest free for reference count. Given that small reference counts are desirable to hide the encoding mechanism, the bits are more than enough for the counting purpose.

If the memory manager is implemented in a context with garbage collection (e.g. 1013/DEL/2013 (PCT/IB2014/060291), and 2713/DEL/2012 (PCT/IB2013/056856)), the reference counting mechanism may be eschewed in favour of the garbage collector. Otherwise, the reference counting mechanism provides a means for reclaiming the storage space for encoding pointers, once the pointers have disappeared.

In the continuing example of a 4-byte integer scalar, any scalar may be encoded with 4 encoding pointers, each pointer decoding to one of 256 values for a byte part. These encoding pointers all share the storage for encoding pointers, comprising the structs discussed above. The base pointer may also be shared and made available using a shared global variable for the scheme. Similarly, any scalar of k bytes, can be encoded using k shared-storage encoding pointers with a total storage bill of 256*sizeof(struct) bytes. If reference counts are ignored, then all the scalars in a program can be encoded using these shared storage pointers for the nominal storage bill. This however, is not desirable since it may lead to the recognition of the scheme by an adversary. So reference counting upto the maximum count representable in a struct (7 bits in the example above), can be used to share a pointer, after which, a new struct can be created with a new pointer encoding for the part value being encoded. In this one-to-many scheme, multiple structs, with corresponding pointers represent the encoding for one part value.

The dereferenced pointers are used above to compute a part's value based on pointer arithmetic. From an obfuscation perspective, these pointers can be dereferenced periodically to collect statistics about the data stored in an allocated region so that some useful work is done on the side to obfuscate the purpose of the encoding pointers. This statistics collection (e.g. how many fields have odd values and how many even), can be done by the memory manager itself or by code generated in the source-to-source transformation.

In a one-to-many scheme, as discussed above, the base pointer can be made different for different struct sets as follows. For the 256 values represented by one set of structs, one base pointer can be used. For new structs generated beyond these, e.g. due to running out of reference count, another base pointer can be used. Once this struct set is exhausted, another base pointer can be used for the next set and so on. Thus the pointer arithmetic scheme can be varied for each of the many representations used for encoding a part in a one-to-many scheme. In order to be self-contained, the allocation region has to be changed per struct set, so that an encoding pointer's decoding method can be identified by the allocation region it falls in.

The specific encoding/decoding scheme (from scalar part to pointer and vice versa) used in a one-to-one or one-many scheme is best implemented as a macro taken from a pluggable set of macro options. The allocation region identification may be used to drive the specific macro code to be invoked.

Further, more bits can be used to encode a part than the minimum necessary to entertain more complex pointer arithmetic. For example, if 10 bits are used to encode a byte part, then a stride of 3 can be used in the decoding dereferenced pointers, utilizing total of 256*3 values which are representable in 10 bits. For a larger prime number, e.g. 5 or 7, 8+3=11 bits suffice for encoding a byte. For prime numbers up to 16, e.g. 11, 13, 8+4=12 suffice. The number of bits left for reference counting go down in this case, e.g. to 4 or 3 respectively, which may be enough for good obfuscation.

From an obfuscation purpose, it is best if reference counts are not implemented at all, and a scheme analogous to one-time pad is used. In this case, the structs are not shared, an encoding of a scalar part leads to leads to the creation of a struct afresh for itself and the struct is not used for anywhere else in the program. So as encodings are generated, new structs and pointers are generated. The de-allocation of the structs can be done explicitly, if the position where a scalar is freed (i.e. its encoding pointer is freed) is identifiable, e.g. a local variable upon exiting its scope, so long as the value does not escape. Else, the de-allocation can be left to a garbage collector, e.g. 1013/DEL/2013 (PCT/IB2014/060291), and 2713/DEL/2012 (PCT/IB2013/056856). Once a struct has been de-allocated, the storage can be returned to the memory manager or the struct used to code another same or different scalar part value according to the same or totally different encoding scheme. It is to be noted that with the reference count field abandoned, the minimum size of an allocated region for a byte-sized scalar part comes down to less than one kilobyte of memory. This allows a large number of allocated regions to be extant and used in conjunction with the one-time pad/pointer scheme discussed here.

In an optional additional technique for obfuscation, using techniques, as in 1013/DEL/2013 (PCT/IB2014/060291), and 2713/DEL/2012 (PCT/IB2013/056856), the memory manager can track an aggregate object's size in the metadata kept for the object. The size can reflect the un-fattened size of the unobfuscated aggregate object. The size of the fattened object can be stored alongside, or computed straightforwardly from the (unfattened) layout information also stored with the object (as in 1013/DEL/2013 (PCT/IB2014/060291), and 2713/DEL/2012 (PCT/IB2013/056856)). Accessing an object for a scalar read or write maps straightforwardly to the read/write of a set of encoding pointers for a fattened version of the scalar. The offset of each such encoding pointer, into the fattened version of the object is known from the position of the scalar in the unfattened object. To allow obfuscation and redistribution of an object's data, the set of encoding pointer offsets can be re-mapped to a set of actual offsets into the fattened object that the pointers are stored at. For example, the positional offsets of encoding pointers may be re-mapped to actual offsets by adding or subtracting a constant, modulo the size of the fattened object. In another example, only the pointers at even offsets may be re-mapped within themselves, and in yet another example, the odd ones may be re-mapped differently, and so on. The actual offsets make up the storing positions for the pointers in the fattened object. Thus the operations of reading/writing a scalar acquires an additional step of computing and using the actual offsets for encoding pointers using the fattened object size. In this manner, all bytes representing fields, bitfields, and padding in the original, unobfuscated object can be accessed as the encoding pointers for their parts at actual offsets computed for them in the fattened object.

Since the re-distributed objects comprise a subset of the program objects (not all the application is obfuscated), such objects may be marked distinctly as such. This may be done my flagging an object in its metadata, alongside the size information for the object.

In a further variation of the above optional technique, object re-distribution may be carried out in an inter-object manner over the flagged objects. For this a participating list of flagged objects is tracked, sorted by memory address, within the combined storage of which, re-mapping is done as exemplified earlier (e.g. all pointers are shifted a constant offset up in address, round robin, in the sorted address space, which corresponds to a constant addition, modulo total size; and so on). Periodically, the participating list of flagged objects is revised, to account for further allocations and de-allocations, with de-allocations prior to a revision being deferred till the revision point itself (as per the deferred de-allocations discussed 1013/DEL/2013 (PCT/IB2014/060291), and 2713/DEL/2012 (PCT/IB2013/056856)), so that a de-allocation prior to revision does not destroy the pointers for other objects stored due to re-distribution in that object. A revision may be carried out straightforwardly as follows: using temporary space equal to the sum of the total size of the present participating objects list and the allocations to be added to the objects list, the data in the present objects is copied contiguously to the temporary space, followed by the data of the additional allocations. Next, minus the data for the de-allocations to the present list, the data is copied back, along with the data for the additional allocations, all re-mapped to the new participating objects list. The de-allocations, deferred till this point, are now carried out by the memory manager as usual, in accordance with 1013/DEL/2013 (PCT/IB2014/060291), and 2713/DEL/2012 (PCT/IB2013/056856).

Analogous to object re-distribution is fat scalar scalarisation for local variables allocated on the stack. Each encoding pointer for a fat scalar gets a distinct local variable name or accessor. The encoding pointers for the various local variables in a function are shuffled among themselves as in the re-distributed objects above by shuffling their order of declaration. The stack frame representing storage for the local variables is fattened like the heap object above. For accessing a scalar, its scalarised individual encoding pointers are accessed using their accessors from their shuffled locations on the stack frame. This scheme suffices so long as there is no garbage collection in the obfuscation system. If garbage collection (GC) is sought, the garbage collector has no way of figuring out which encoding pointers in the shuffled locations make up a pointer scalar and hence cannot collect such pointers from the stack.

To allow scalarisation supportive of garbage collection, stack frames containing pointer scalars are shifted to the heap. This allows the frame to become an ordinary heap object, supportive of re-distribution of encoding pointers. The heap object, as in 1013/DEL/2013 (PCT/IB2014/060291), and 2713/DEL/2012 (PCT/IB2013/056856) has access to object layout that identifies the locations of pointer scalars. Using this, the garbage collector can calculate a pointer scalar from its encoding pointers and thus collect the pointer. Garbage collection for heap objects alone is straightforward, given the object layouts available for them in 1013/DEL/2013 (PCT/IB2014/060291), and 2713/DEL/2012 (PCT/IB2013/056856).

The scalarisation scheme for local variables becomes as follows: A call to a function f with a pointer scalar containing stack frame is transformed to the sequence:

frame_ptr=create_frame(fat arguments); f′(frame_ptr); reclaim(frame_ptr);

In this sequence, create_frame( )creates a heap object containing the redistributed fat scalar arguments. The function f′( )is a transformed version of f( ) wherein local variable accesses are replaced with field accesses over the frame pointer. Reclaim( )returns the frame pointer, for reuse later or deallocation. In this pseudocode sequence, frame_ptr itself is an obfuscated fat scalar. It is scalarised as described above for the non garbage collector case.

When a frame is created, it is doubly linked to presently live heap frames that have already been created. The list of presently live heap frames is a stack in itself, representing the order of creation of the frames. The doubly linked structure, is made up of obfuscated pointer scalars (fat scalars). Create_frame( ) and reclaim( ) push and pop the frame on this stack. With this, the call f′(frame_ptr), wherein the scalarised frame_ptr is carried on the normal function stack does not require the frame_ptr to be collected from the normal stack by the garbage collector. The garbage collector can ignore this pointer. The pointer is available from the doubly-linked stack of frame pointers constructed by create_frame( ). Hence, frame_ptr can undergo scalarisation as in the non-GC case and yet work with GC.

For efficiency, create_frame( ) and reclaim( ) can minimize object allocation and deallocation by saving a returned frame on an unused frames list and reusing from the list first in creating a new frame. Reclaim( ) scrubs each returned frame of all pointers in this endeavour so that the garbage collector does not end up chasing pointers from an unused frame.

In the above, preferably, create_frame( ) is implemented as a macro or inlined code, to obfuscate its functioning.

A further optimisation in the above GC-supportive scalarisation scheme is to lay out the heap frames on the normal stack itself. In other words, to inline a heap frame on the stack and to somehow insert a layout also in the stack frame. This requires close integration with the specific compiler used for compiling the program, since the stack implementation is tied to it.

The re-distribution or scalarisation scheme described so far can be further enhanced to include false scalars interspersed in-between pointer encoded scalars. To do this, a fat aggregate object is magnified in size, e.g. multiplied by a prime number, with encoding pointers accessed by appropriate striding through the object. The storage left unused in-between encoding pointers can be filled with false scalars, whose only purpose is to obfuscate the data structure. The false scalars can be accessed as normal scalars, with say statistical computation and assignments etc. carried out over them for obfuscation reasons.

If the user decides not to obfuscate all scalars in a procedure or file, the obfuscation mechanism can carry this out as follows. The unobfuscated scalar is fattened, just like an obfuscated counterpart, but the enhanced storage carries the plain scalar directly. It is accessed and used directly from say the lower bytes in the larger storage. No encoding via pointers of its parts is carried out. Such an unobfuscated scalar looks like the false scalar described above, in a data structure. However, it is not false and actually serves a useful purpose.

In the reference counting mechanism discussed above (which is not used in the one-time pad/pointer scheme), incrementing a reference count occurs when an encoding pointer is reused to represent a scalar part. For this, the memory manager needs to be able to locate the encoding pointer, which may be carried out as follows:

Using object metadata as in 1013/DEL/2013 (PCT/IB2014/060291), and 2713/DEL/2012 (PCT/IB2013/056856), where allocated objects are partitioned by size, a struct pointed by an encoding pointer may be isolated from other program objects that have a different size. For the objects of the same size as encoding pointer structs, generated by the application, a filter function or macro is to be provided as a part of the application, that identifies an object as an application object or not. Using this filter, the partition of objects the size of encoding pointer structs is traversed, doing a reverse mapping for each non application object to identify its scalar part. Once a struct with encoding pointer has been located with the sought value for scalar part, the encoding pointer is reused in encoding that scalar part and the reference count incremented. Note that in this method, no forward mapping table is used, which can aid an adversary, inadvertantly. The search through structs may be sped up by organising them in the memory manager according to the allocation regions they correspond to (e.g. a later allocated region has its encoding pointer structs allocated later). Also, the use of smaller allocation regions and fewer structs per region speeds up the search.

Note that when a larger number of bits are used to encode dereferenced pointers pointing to a region, for example for striding by primes, a large number of pointers are left unused, which can be used to record reference count information. For example, when striding by a prime number k, the k-1 pointers are left unused in each stride. All the k pointers passed in one stride may be considered as encoding the same part information, with the k distinct values defining k different reference counts. By this mechanism, the reference counting mechanism can recover some of its representation space, ceded to the part encoding mechanism.

The obfuscation mechanism is best implemented in an untyped program image, where the lack of type information makes it harder for an adversary to understand the data. So for example, a flattened C/C++ image, with lack of information on what comprises pointer and non-pointer data aids obfuscation. The obfuscation mechanism straightforwardly can randomise or strip the lexical symbols like variable names in a program, using a source-to-source transformation, so that the binary code and associated tables become harder to read or reverse engineer. A Java source can be translated to C++ enroute to class flattening and C compilation to strengthen the obfuscation via compilation to native code.

The invulnerability guarantee for pointers for GC (as in 1013/DEL/2013 (PCT/IB2014/060291), and 2713/DEL/2012 (PCT/IB2013/056856)) can be straightforwardly kept by allowing the GC system to carry out the further encoding to obfuscated fat pointers. The obfuscation and GC systems can be combined into an integrated system for this purpose.

The reachability of fat scalars, including fat pointers needs to be traced through the program, just like singleword pointers are propagated in prior art. This is to permit the appropriate handling of fat scalars, including insertion of encode and decode operations at appropriate locations. Cast operations, like the decode( ) operation of 1013/DEL/2013 (PCT/IB2014/060291), from fat scalar to scalar or vice versa may further be allowed. The propagation can either be done by user annotation and/or static analysis, such as the static analysis 1013/DEL/2013 (PCT/IB2014/060291). The system may provide the property that all objects reached by an operation such as read/write are either fat objects or normal objects. This allows doing away with carrying run-time tags with objects stating whether they are fat or thin, since fat objects are always treated by fat operations and thin objects are always treated by thin operations (refer singleword and doubleword pointers of 1013/DEL/2013 (PCT/IB2014/060291). Such a bifurcation is also convenient for obfuscating object metadata also, in case of fat objects, since the fat operations accessing them can process the metadata accordingly. Obfuscation of object metadata brings the run-time program closer to the untyped program image ideal, discussed above.

It is desirable for the obfuscation system to generate code in its source to source transformation wherein fields are destablised additionally to being encoded. So for instance, a read-only field is periodically side effected back and forth to make it appear non read-only, while the non-spurious uses all end up with the safe read-only value. The control flow graph can be de-stabilised to compute extraneously, e.g. allocation region statistics discussed earlier, to hide the valuable computation. The continuation for a computation can be recorded in a “program counter” structure, for example, the index of an iterative loop being such a structure, and diversions from the main computation carried out extraneously while tracking the real continuation (index) carefully in hiding the program flow. Computation of substeps comprising different steps can be re-ordered to merge and diffuse the steps into each other, obfuscating control flow. Fields can be duplicated, additionally to being encoded, with the duplicated fields being mirror images only upon non-spurious use and not otherwise. Migration of field storage can be supported, for example, as done in the inter-object re-distribution mechanism discussed above, to make fields hard to discern. Garbage collection with object relocation aids this endeavour, e.g. as in 1013/DEL/2013 (PCT/IB2014/060291), and 2713/DEL/2012 (PCT/IB2013/056856), that can be provided by the obfuscating memory manager.

The cryptography code is preferably generated in a source-to-source transformed common set of files for both application and cryptography code so that the codes are undistinguishable from each other. This is preferable over say linking as a dynamically linked library (DLL) that is straightforward to identify.

Finally, it is to be re-emphasized that 1013/DEL/2013 (PCT/IB2014/060291), and 2713/DEL/2012 (PCT/IB2013/056856)) entertain both singleword and doubleword encoded pointers, both of which can be catered to by the obfuscation system presented here. The user's indication of singleword or doubleword preference may be incorporated in the compilation process for the system.

Attack Scenarios, Bounded by Time and Partitioning

A distribution system for a multimedia and text combination asset is disclosed. The asset comprises a software player that hides one or more keys or cryptography implementation within itself and is bundled with a combination of video, audio, or text data in encrypted form. The software player can decrypt and play the data or encrypt and add data, without requring any customer-specific symmetric or assymetric key or password to be input or made available during installing or running the player.

According to an embodiment, the software player thwarts simple data capture mechanisms comprising one or more of screen bitmap capture, screen text clip capture, screen text clipboard capture, or audio clip capture.

According to another embodiment, the hidden keys or cryptography implementation of the software player comprises an expiry date or mechanism so that the player does not work after the date or mechanism disallows it.

According to yet another embodiment, the software player enables a free or priced update with a continuing player of a different hidden keys or cryptography implementation, upon expiry of the player.

According to an embodiment, the update recurs with a well-announced expiry date for planning convenience.

According to another embodiment, data bundled with the software player is reduced to a small partition. The remaining one or more data partitions may be bundled and distributed with one or more other software players, each comprising distinct hidden keys or cryptography implementation.

According to an embodiment, no plaintext fragment of encrypted data is exposed by the distribution system to a user, other than possibly only sale-related input such as buyer details or payment details.

A distribution method for a multimedia and text combination asset is disclosed. The method comprises a step of encrypting or decrypting a combination of video, audio or text data bundled with a software player, using the hidden keys or cryptography implementation of the software player such that no customer-specific symmetric or assymetric key or password is required to be input or made available during the installing or running of the player.

An authenticator (downloaded software asset, or the code invoked for a particular potent) is identified by the potent version it handles. This comprises a specific cryptography implementation within the potent, including hidden keys and data.

The scheme presented herein is strong in that none of its cryptographic workings display the plaintext version of encrypted data to a user at any stage. The authentication dialogue and the copyright enforcement all deal with internally generated and encrypted data by potents or authenticators. The plaintext is never made available. Secure selling has an element of user input (e.g. buyer name, credit card information) that is plaintext input, but such input is small and can easily be diluted with other data to be encrypted. Some of this information, e.g. buyer name, may also be carried in the clear (un-encrypted or semi-encrypted) to hide the encryption process. Sometimes the sale information is simply not there e.g. when giving away software freely in a sale or promotion, or when the software is not sold by itself (e.g. the monitor software discussed later, that's likely bundled with an operating system transaction).

For an attacker to break secure selling, he is likely to make multiple purchase attempts to get sale-related plaintext to work with. The attempts can be forced to be staggered, if too many attempts are clustered, or denied altogether after a threshold. In a more restrictive scenario, an alternative is to not let the potent collect sale data. The selling can be done by the delegated sales means, wherein the delegation identifier does not directly represent plaintext user data (it might compute and represent a hash of the plaintext and/or machine context, thereby not exposing plaintext encryption to an adversary).

As discussed above, the strong cryptography system presented herein can be made stronger still. We discuss next, further safeguards and safety strategies for the system, against attacks.

If a potent is compromised in an attack, then all its cryptography functions as well as the corresponding authenticator's functions become unreliable as follows:

Authentication With cryptography compromised, a potent masquerader can fool the cryptographic check of an authenticator. However, the non-cryptographic hash checks of the authenticator continue to remain in force. The demonstration of functionality and informal knowledge of antecedents add depth to the level of authentication. Hence authentication, generally albeit informally continues to hold even if cryptography fails. Detailed hash tests are important in such authentication, so authentication by website also (like a downloaded authenticator) has to compute enough hash data in its checking.

Sales Secure, sales, directly from a potent may be carried out, but the information can be intercepted and stolen on the way since the data can be decrypted. A masquerader can be distributed that mimics the potent only to capture sales information from duped customers. Both these scenarios face logistical problems, since an interception can only occur at the location of a buyer, which is unknown at any time. As regards a masquerader, it is likely to continue failing authentication as discussed above.

Copyright The context of an environment can be decrypted to recognize the information. Thereafter, the context can be re-created on any machine to freely run the software on that machine without any sales. In other words, a potent can become freeware after it has been compromised.

If a potent version is distributed with an expiry date, e.g. an expiry flag that the potent must occasionally read from the content provider's website, then the potent can stop running soon after the expiry occurs. Such a choice bounds the time within which a successful cryptographic attack needs to be carried out, making it harder to do. Beating authentication, with its additional checks is a strictly more harder problem to carry out within the time window. So organized data theft, using say a masquerador, in the context of a potent with an expiry date is an unlikely problem, for reasonably sized time windows. Further, a time window also limits the loss through copyright subversion as all copies expire. Upgraded potents with new version numbers replace only the potentates as potentates, free of charge, while others have to make a purchase of an upgraded potent to reach potentate status.

For multimedia data bundled with potentates, broken cryptography is a serious problem, since the data once decrypted can be freely circulated independently of potentates. The time window helps, as it reduces the chances of breaking cryptography. Further benefit can be obtained by partitioning multimedia data among a set of potents, each with a unique cryptography version, distinct from others. In order to play the data, all the potents have to be downloaded and played in the sequence of played data, viz. a potent is played when it is needed to decode the played data. The partitioning of data among potents can be done to make each partition un-interesting to an adversary. For example, no partition should contain a complete album by an artist, as that might be worthwhile to a pirate to mount an attack. No partition should contain the best hits of an artist, since again, that might be worth attacking to compile the greatest hits by the artist.

To contain the number of potent versions to circulate, they can be re-used to play other multimedia data. So for instance, a set of hundred potents can be standardized upon. Supposing that the total number of albums in the market number fifty, the fifty albums of say twenty songs apiece can be distributed at will among the potents, with each potent getting ten songs on average. The partition of each potent can be selected to not be of commercial interest to anyone (random songs, not generating a theme or album of interest to a pirate). The hundred potents can be sold free at the outset to any buyer and copied/downloaded once to reside in his hardware player/computer. The data then streamed or downloaded in, partition by partition, can be paid for and tracked separately on a potent by-potent basis. Each potent would be organised with expiry dates, so that it would upgrade automatically, free of charge upon expiry, deleting its expired data partition and acquiring (or generating) a new substitute in its place.

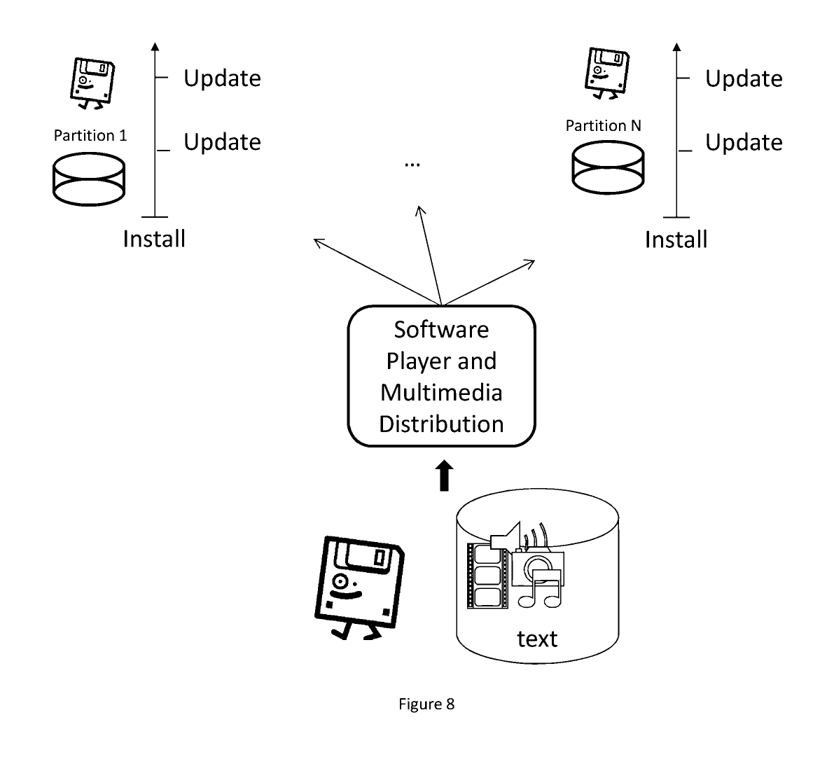

FIG. 8 summarizes the structure of multimedia/text potents. An original potent (shown as a diskette with legs icon) at the bottom of the figure and all bundled data is replaced by a set of N potents at the top, each potent being responsible for a partition of the bundled data. Installation now comprises installation of the N potents and data partitions on a machine. Each potent and data partition evolves according to its shown timeline, with well known update schedules, allowing data to be kept encrypted safely for a long duration. Piracy is minimized, made harder, and un-interesting on a potent-by-potent basis.

Authentic Client Software Including Browser and Updates

A software authentication and installation monitoring system is disclosed. The system comprises a means for hiding one or more keys or cryptography implementation. The system further comprises a means for tracking authentic software or certified software or user-built software installed on a machine by storing the information in encrypted form on the machine using the hidden keys or cryptography implementation. The system further comprises a means for mediating in a software installation, ensuring that authentication steps are carried out that ensure the authenticity of the installed software. The system further comprises a means for disallowing a user setting the permission of a file to execute, unless the file is known to be built or certified by the user or known to be authentically installed as per the tracked information. The system further comprises a means for disallowing an executable file to run, unless the file is built or certified by the user or known to be authentically installed as per the tracked information. The system further comprises a means for stopping a running program, if the running program is found to not be user built or certified, or authentically installed as per the tracked information. The system further comprises a means for scanning the machine periodically, resetting the execute permissions of any unknown files.

According to an embodiment, the system updates an expired or expiring software with a successor software having different hidden keys or cryptography implementation.

According to another embodiment, the update recurs with a well-announced expiry date for planning convenience.

According to an embodiment, the system installs and periodically updates an authenticated browser.

According to an embodiment, no plaintext fragment of encrypted data is exposed by the system to a user.

According to an embodiment, the distribution system installs an authenticated digital asset on a machine where installed software consists of authenticated assets only.

According to another embodiment, the asset installation is mediated by a monitoring system on the machine.

According to an embodiment, the asset installation installs and periodically updates an authenticated browser.

According to an embodiment, the monitoring system disallows unmediated asset installation by resetting execution permission or disallowing a file with execute permission to run, or stopping a running software.

According to an embodiment, secure selling is carried out even on a machine with un-authenticated software.

A software authentication and installation monitoring method is disclosed. The method comprises the steps of (a) hiding one or more keys or cryptography implementation; (b) tracking authentic software or certified software or user-built software installed on a machine by storing the information in encrypted form on the machine using the hidden keys or cryptography implementation; (c) mediating in a software installation, ensuring that authentication steps are carried out that ensure the authenticity of the installed software; (d) disallowing a user setting the permission of a file to execute, unless the file is known to be built or certified by the user or known to be authentically installed as per the tracked information; (e) disallowing an executable file to run, unless the file is built or certified by the user or known to be authentically installed as per the tracked information; (f) stopping a running program, if the running program is found to not be user built or certified, or authentically installed as per the tracked information; and (g) scanning the machine periodically, resetting the execute permissions of any unknown files.

What is trustworthy? An https website represents a company, so that may be considered as trustworthy as the company and can be held as authentic as such. Now how about the access to the website? In accessing the https website, is the browser authentic? Is any software on the client computer authentic? Unless a customer has a guarantee, an ambush can be launched from any unproven client resource. After all, how does a customer know whether the browser he uses from a cyber cafe or hotel lounge is giving it a secure transaction using say, a credit card?

On any client machine, before accepting a networked delivery of authentic software, the receiving software on the client side, that interacts with the customer, has to be proven authentic. This, frankly is a chicken and egg problem in the software industry (secure software is not delivered because it cannot be received securely, secure software is not received securely because it has not been delivered), that only accepts one physical solution—the machine has to come with a warranty as such from the original seller of the machine. Further, the warranty has to ensure that the updates the machine accepts in its life are not going to break the warranty. In this section, we show how our method allows the provision of such a warranty by software sellers.

First, the original machine can be loaded with a physically authenticated original software by the machine manufacturer according to our method, straightforwardly. All software necessary for the safe functioning of the machine can be preloaded thus, making the machine secure at the original sale time by the manufacturer. Next, an authenticated update to software, to the authentic client machine thus, in the life of the machine later can be carried out as follows:

Step 1 In this step, the current paint file, inclusive of the context of the machine is transmitted in the encrypted form to the content provider. The content provider after decrypting the context, re-encrypts it according to the cryptography implementation of the version of the software that will replace the present software. The present software inclusive of the paint file is deleted from the client machine.

Step 2 The new software copy is sent to the client machine using a secure protocol such as https, preferably, simplifying the authentication step. The sale step is carried out free of charge or for the seller determined fee, by a recognition of the client context as follows. The under-sale new potent computes and sends the machine context to the content provider (e.g. as a part of the delegation id or direct sale data) and the content provider after recognizing it applies the relevant free or cost charge to the buyer. After the sale, the installation proceeds as usual and the new software completes its replacement of the earlier software.

In this scenario, the content provider receives many update requests from clients. Not all the clients need be authentic. The content provider can safely ignore this fact and treat the clients uniformly, as a subverted machine can at most only corrupt the sale price of the new software and not affect the replacing software (version) in any manner. If the next software version survives subversion, then the sale corruption does not last beyond one update and the newer softwares can continue working safely thereafter.

In an authentic client, all softwares pertinent to the safe functioning of the client are allowed only authenticated updates as described above. Monitoring software to ensure this can be provided as a part of the operating system or system software for the machine. The monitoring software straightforwardly mediates between the user and the content provider, to ensure all needed authentication steps are carried out correctly in any update supervised by the monitor. The monitoring software itself may undergo regular updates to keep its cryptography implementation out of reach of subversion. Regardless, since authentication itself is unlikely to be subverted, as discussed earlier, the periodicity of such updates may be low.

The monitoring software can allow fresh installations of new software by a user. This would allow any version of an authenticated software to be installed as new software on the machine. As before, all authentication steps would be confirmed by the monitoring software for a content provider with an https website for downloading the software or authenticator. An update attempt, disguised as an installation of software in addition to an already installed software for a content provider may be disallowed by the monitoring software by recognizing its https page identity.

Software installation unsupervised by the monitor can be prevented by the monitor periodically scanning the file system for executable files and resetting their execute permissions to a non execute status, if the files are not known to be installed authentically. As discussed later, the monitor would keep with itself, in encrypted form, the knowledge of all authentic installations on the machine. If a user tries to set a file back to execute permission, the monitor would enter into a dialog with the user demanding that the user certify the safety of the file. By certifying an unknown file thus, the user in effect takes responsibility for the file, just as he does for executable files built by himself. Furthermore, the monitor would intercept any executable run attempt and check its authentic installations status (or user certification/build) prior to letting the executable run. For an executable on a removable medium where the permission cannot be reset, e.g. a compact disc, the monitor may simply disallow the executable to run, forcing a supervised installation of the executable prior to running. For boot-time running of an executable off removable media (e.g. using BIOS or Basic Input/Output System), when the monitor may not be running yet, the monitor can do a checking of installed files after booting to choose resetting permissions of any newly installed files. Similarly, the any executables loaded and left running after booting can be chosen and shut down by the monitor to contain the running processes to only authenticated ones. The monitor may do this prior to general network access by the client machine so that only the authenticated executables are exposed to the network by the client machine.

For software development environments, the monitor may allow software builds the exception of execute permissions straightforwardly (e.g. by tracking the location at which the executable is built and optionally copied under supervision), disallowing only unsupervised copied software the capability of execute permissions. Tracking installations and user built/certified executable locations is carried out by storing the information locally on the machine, in encrypted form so that the information cannot be subverted. Cryptography hiding for this purpose may be carried out by our method, with occasional periodic updates ensuring that the system survives all subversion attempts. Note that even if the cryptography of a monitor is subverted, an executable taking advantage of the information cannot be run on the machine without proper installation, which would be denied to an adversary. Thus the monitor is a safe mechanism for implementing authentic clients.

Software installation by piece and part, e.g. dynamically-linked libraries, may be straightforwardly folded in by updating piece by piece while running the potent/potentate as a whole to carry out the steps.

Browser software in particular may be warranted authentic by the mechanism above. Since https protocol is assumed by the mechanism above, the step of deleting existing browser software may be carried out after the newer version has been fully installed and has taken over the charge of all https communication.

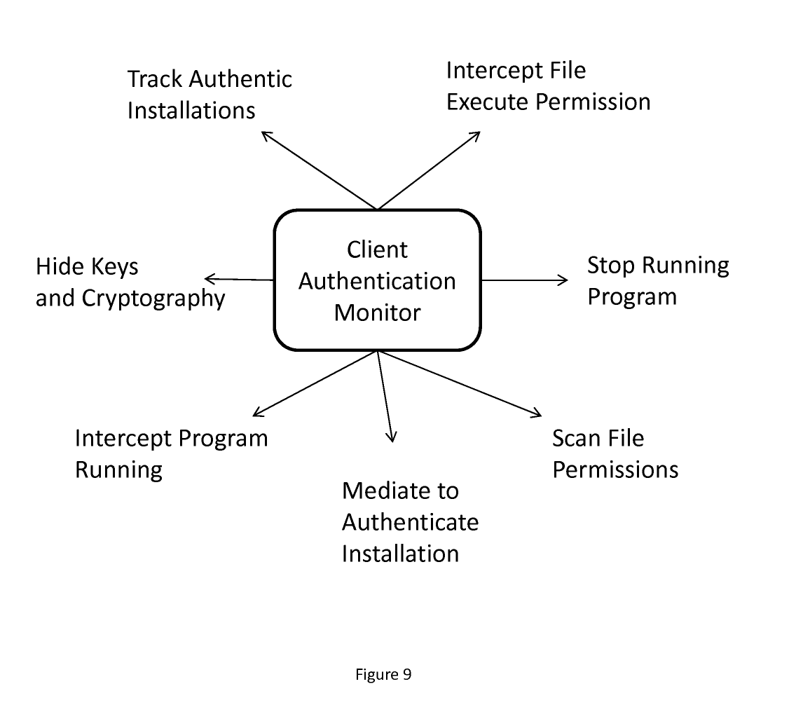

FIG. 9 summarizes the structure of an authentic client monitor, whereby installation of only authentic software or user built/certified software is carried out on a machine. The monitor is built with our hidden keys or cryptography mechanism so that it can encrypt or decrypt data privately. This is used to track the present set of authentic software installations on the machine. Included in this set are also user built or certified executables so that the user is responsible for ensuring the safety of this part. The monitor intercepts file execution permission changes, so that a file is not allowed to have execute permissions unless it falls in the tracked set of authentic softwares or is user built/certified. The interception may involve a dialog with the user for this purpose. The monitor can stop a running program, if it finds that the program does not fall in the allowed tracked set. The monitor periodically scans the machine for files with execute permissions, resetting the same, if the file is not in the allowed tracked set. Such scanning can be carried out as a background activity occasionally, so that the load on the machine is reduced and the various interceptions carried out by the monitor are lightweight (the interception work is reduced by this scanning). The monitor mediates in program installation and update so that only authentic program installations or updates occur. Whenever a program is run, the monitor intercepts the step, so that only a tracked, allowed program is allowed to run. The monitor may initiate a dialog with the user prior to acting on its decisions, in case its tracked data is likely to be informed by the dialog (e.g. about user build/certification status).

A public key cryptography mechanism may be argued as a more capable method, since the public key does not need to be hidden. It is to be noted however, that a client with a public key can decrypt only public information broadcast by a content provider, since the communication can be intercepted and decrypted using the public key. The public key allows a client to encrypt data that can only be decrypted by the content provider, without interception and decryption by an adversary. No further capability is available to a public key carrying client and larger capability, such as both encrypting and decrypting local data or offline operation requires the client to carry secret data/keys, for which our method provides the most effective solution.

Besides offering the capability to deliver authentic software to authentic clients, our method is capable of authentic software delivery and secure sales to non-authenticated clients also. For example, physical delivery of authentic software to such a client may be carried out with secure sale either directly or by delegation. Secure sale here is underpinned by the fact that encryption/decryption is carried out at the application level (hidden of course) so reliance of security on lower layers of communication is not needed. This is a novel contribution of our work. Further, once such software has been spread to authentic clients and others, copies of the same may be propagated further to other clients accompanied by secure sales. The larger the spread of such authentic software, the larger is the set of sources from which software copies can be distributed further. Thus authentic software delivery is maximized by our work, a further addition to the contribution above made by our work.

Since authentication is unlikely to be undermined by an adversary in our work, the calendar of software upgrades can be advertised. So the profusion of offline authenticators in the network can be planned and used more capably by the users, monitors and content provider, all parties to the software distribution. Again, this is a unique contribution of our work.

Our work, and its physical delivery opportunity, maximizes the spread of authentic software, whether authentic clients are present or not. When secure network is warranted, then network delivery can be maximized. When such warranties are not present, then physical delivery from a large spread of sources can be maximized. Regardless, the authentic software spread is maximized.

Expanding the pie: Each time a buyer takes a risk with an unsure asset (antecedents partially known), and makes a successful purchase using a secure payment channel, the number of known authentic seats for authentic software increase—it is known that the purchased software talks to the provider correctly. Even if the cryptography of the software is undermined, the adversary has no gain in such purchases. Such a software purchase increases the informal authentication confidence, but not formal authentication count. Such sales can proceed in concurrence with the formally authenticated sales. The analog of such risk taking just does not exist in other authentication mechanisms, that are secure website/receiving client software driven.

Remarks

Distributed potents and potentates can be shut down variously as follows. (a) Stop sales: E.g. shut down keys and rest. (b) Make it free thereafter: Make public a freeing coupon. Make it year by year, so that renewals are needed to continue endlessly. (c) Put expiry dates or lifetimes: potents potentates shut thereafter. Renewals can be by updates at each expiry.

Pointer based encoding poses formidable challenges to an adversary. First, pointer analysis is known to be intractable, so the system is not amenable to static analysis. Dynamic interpretation of the binary code using tools of capability similar to valgrind may be the only resort and these are hampered by the steganography and abstraction/representation obfuscation carried out herein.

The steps of the illustrated method described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

FIG. 8 illustrates a computer system 1000 in which the asset distribution system may be implemented in accordance with an embodiment of the invention. The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the process in order to implement the inventive concept as taught herein.

What is claimed is:

1. A distribution system operable in a computing environment for binary-encoded digital assets, comprising:
(a) a hiding means for hiding one or more keys or cryptography implementation in a digital asset;
(b) a copying means for asset distribution for receiving a functionally-restricted asset copy for use or further distribution, directly or as a further copy, with or without access to a computer network; and
(c) a self-policing means for enforcing asset safety, comprising:
i. an authentication means for an un-authenticated, digital asset for constructing encrypted credentials data using one or more keys or cryptography implementation hidden in the asset by the hiding means, for authentication by an authenticated digital asset or website;
ii. a secure selling means for an authenticated digital asset for either carrying out a sale transaction directly, securely, or delegating the sale to a separate secure means, identifying the delegation by an encrypted identifier constructed using one or more keys or cryptography implementation hidden in the asset by the hiding means and decrypting the response from the secure means using the one or more keys or cryptography implementation hidden in the asset to determine the success of the sale; and
iii. a copyright and license enforcement means for an asset for carrying out encryption and decryption of computing context and other data using one or more keys or cryptography implementation hidden in the asset by the hiding means, with functionally-unrestricted asset use permitted only after the asset has been sold and licensed to run in a recognizable computing context.

2. The system of claim 1, wherein an asset comprises software.

3. The system of claim 2, wherein the asset further comprises a combination of encrypted video, audio, or text data bundled with the software, and the software is a software player to decrypt and play the data or encrypt and add data.

4. The system of claim 3, wherein the software player thwarts simple data capture mechanisms comprising one or more of screen bitmap capture, screen text clip capture, screen text clipboard capture, or audio clip capture.

5. The system of claim 2, wherein the hidden keys or cryptography implementation of the software comprises an expiry date or mechanism so that the software does not work after the date or mechanism disallows it.

6. The system of claim 5, enabling a free or priced update with a continuing digital asset of different hidden keys or cryptography implementation, upon expiry of the software.

7. The system of claim 6, recurring with a well-announced expiry date for planning convenience.

8. The system of claim 3, wherein the data decrypted or encrypted by the hidden keys or cryptography implementation of the software player is reduced to a small partition so that the remaining one or more partitions may be bundled with one or more other software players, each distributed with its own distinct hidden keys or cryptography implementation.

9. The system of claim 1, installing an authenticated digital asset on a machine with installed software consisting of authenticated assets only.

10. The system of claim 9, wherein the asset installation is mediated by a monitoring system on the machine.

11. The system of claim 10, further comprising updating an expired or expiring asset with a successor asset of different hidden keys or cryptography implementation.

12. The system of claim 11, further comprising the update recurring with a well-announced expiry date for planning convenience.

13. The system of claim 12, further comprising installing and periodically updating an authenticated browser.

14. The system of claim 10, further comprising disallowing unmediated asset installation by resetting execution permission or disallowing a file with execute permission to run, or stopping a running software.

15. The system of claim 1, further comprising the system being operable for carrying out a sale securely, even on a machine with un-authenticated software.

16. The system of claim 1, wherein no plaintext fragment of encrypted data is exposed to a user, other than possibly only sale-related input such as buyer details or payment details.

17. The system of claim 1, wherein the computing context and other data are stored with the digital asset after sale and installation.

18. The system of claim 1, wherein the credentials data constructed by a digital asset are passed to a browser to authenticate.

19. The system of claim 1, wherein a key is stored in a digital asset by distribution into a subset of a large number of candidate data fields in the asset, the reconstruction of the key from the fields not being apparent from a reverse engineered control flow of the asset, forcing a combinatorially large number of key reconstructions to be considered in a key search making key discovery infeasible.

20. A cryptography hiding system operable in a computing environment for hiding one or more keys or cryptography implementation in a binary-encoded digital asset using holistic, efficient steganography, comprising:
(a) an interleaving means for sequentially or concurrently interleaving the computation of non-cryptography, useful code with cryptography code;
(b) an obfuscating memory management means for creating an encoded pointer representation of any scalar, comprising one or more encoding pointers pointing to one or more objects created and managed by the memory management means for maintaining the scalar in an obfuscated state throughout the lifetime of the scalar;
(c) a class obfuscation means for translating a class to one or more data structures or procedures; and
(d) a procedure obfuscation means for de-stacking one or more parameters of a procedure or translating a procedure call to jumps to and from an inlined procedure body.

21. A cryptography hiding system operable in a computing environment for hiding one or more keys or cryptography implementation in a binary-encoded digital asset using holistic, efficient steganography, comprising an interleaving loop or recursive procedure instantiating one or more re-entrant calls to one or more procedures or macros in cryptography code, such that one or more re-entrant calls to one or more procedures or macros in useful, non-cryptography code are interspersed in-between any two cryptography code calls, and that a cryptography call typically comprises a smaller stateful computation than a larger stateful computation comprised by a non-cryptography call.

22. The system of claim 21, wherein the interleaving loop or recursive procedure is parallelized to execute a cryptography call largely in parallel with non-cryptography computation.

23. An obfuscating memory management system operable in a computing environment for creating an encoded pointer representation of any scalar, comprising one or more encoding pointers pointing to one or more objects created and managed by the memory management system for maintaining the scalar in an obfuscated state throughout the lifetime of the scalar.

24. The memory management system of claim 23, wherein the objects are laid out randomly over the heap memory.

25. The memory management system of claim 23, such that the pointer is used only once in encoding a scalar part.

26. An memory management system of claim 23, comprising one or more fields containing one or more pointers to one or more allocated objects, such that the value denoted by an encoding pointer can be obtained by dynamic computation comprising the use of a combination of the object, one or more of the pointers, one or more of other pointers, and the allocate objects.

27. The memory management system of claim 26, further denoting a value of a reference count for an encoding pointer such that the value can be obtained by dynamic computation comprising the use of a combination of the object, one or more of the pointers, one or more of other pointers, and the allocated objects.

28. The memory management system of claim 27, further comprising incrementing the reference count upon dynamically finding a scalar part's encoding pointer using a filter function.

29. The memory management system of claim 27, further comprising reclaiming the object upon reference count elimination.

30. The memory management system of claim 26, further comprising reclaiming or migrating one or more of the object or allocated objects using garbage collection.

31. The memory management system of claim 26, further comprising never storing a scalar or scalar part directly in memory.

32. The memory management system of claim 23, further comprising scalarising the scalar into independent encoding pointers.

33. The memory management system of claim 23, further comprising distributing an aggregate object's scalars' encoding pointers all over the object.

34. The memory management system of claim 23, further comprising distributing a set of aggregate objects' scalars' encoding pointers all over the objects.

35. The memory management system of claim 34, further comprising re-distributing the encoding pointers in the set of aggregate objects, upon increase or decrease in objects due to allocation or de-allocation.

36. The memory management system of claim 35, further comprising deferring an object de-allocation till a further re-distribution for vacating the de-allocated object prior to the de-allocation.

37. The memory management system of claim 23, further comprising initializing the scalar using dynamic computation comprising the use of a set of literals disjoint from the literal initializing the scalar in an un-obfuscated program.

38. The memory management system of claim 23, further comprising one or more fields denoting a value for an encoding pointer or a reference count such that the value or count can be obtained by dynamic computation comprising the use of the object.

39. The memory management system of claim 23, further comprising an encoding pointer representation of the scalar being changed when one or more objects pointed to by one or more encoding pointers are migrated by garbage collection, without changing the scalar's value denotation itself.

40. An obfuscating memory management system operable in a computing environment for allocating or de-allocating an object with meta-data comprising object size or layout such that the contents of the object may be obfuscated by distribution or redistribution, part by part, anywhere over the object or one or more other objects.

41. The memory management system of claim 40, further comprising deferring the object's deallocation till occupants of the object in lieu of parts distributed or re-distributed to other objects have been vacated.

42. The memory management system of claim 40, wherein the object is allocated with larger storage than its meta-data size, so that false scalars or duplicated parts may be used to fill the extra space for further obfuscation.

43. The memory management system of claim 40, comprising a garbage collector.

44. The memory management system of claim 42, further comprising using the layout meta-data to identify or de-obfuscate pointer scalars in the object.

45. The memory management system of claim 40, further comprising scalarizing the object's parts in substitution for object allocation on the stack such that object's encoding pointers are scalarized and independently stored.

46. The memory management system of claim 45, further comprising enabling part-by-part scalarization of all stack-allocated variables of a procedure, such that the variables are shifted to heap allocation only if the variables comprise a pointer scalar.

47. The memory management system of claim 40, wherein the object meta-data itself is obfuscated.

48. A procedure obfuscation system operable in a computing environment for de-stacking one or more procedure parameters, comprising:
(a) a static analyzer means capable of guidance by one or more user annotations; and
(b) a source-to-source transformer means capable of replacing a reference to a procedure parameter with a non-stack reference.

49. The system of claim 48, further comprising sharpening a symbolic value of a variable, location or expression to a subset of a symbolic value generated by a static analyzer.

50. The system of claim 48, wherein the non-stack reference comprises a global variable.

51. The system of claim 48, wherein the static analyzer means further comprises a means for determining that a procedure call has no nested calls to the procedure.

52. The system of claim 48, wherein the static analyzer means further comprises a means for determining that the number of nested procedure calls to a procedure contained within a call to the same procedure is less than a statically-known constant, and the non-stack reference further comprises a global array variable indexed at a nesting depth of a procedure call.

53. The system of claim 48, wherein the static analyzer means further comprises a means for determining that barring procedure return values, all dependencies within a procedure are intra-procedural, and the source-to-source transformer means comprises a means for replacing a procedure with a parameter memoising procedure.

54. The system of claim 53, wherein the static analyzer means further comprises a means for computing a schedule of calls for a recursive computation involving a procedure and the source-to-source transformer means comprises invoking the procedure according to the schedule in a loop or recursion.

55. A computing context storing system operable in a computing environment for storing a computing context, wherein a computing context comprises a narrow time window within which the computing context is stored in the computing environment.

56. The system of claim 55, wherein narrow time windows or exact times of creation or modification of one or more files or folders along with their locations in a computing environment further comprise the computing context.

57. The system of claim 55, wherein the partial content of one or more files or folders along with their locations in a computing environment further comprise the computing context.

58. The system of claim 55, wherein the names of one or more files or folders along with their locations in a computing environment further comprise the computing context.

59. The system of claim 55, wherein functional data related to the accurate working of the computing environment further comprises the computing context.

60. A computing context recognition system operable in a computing environment for handling and recognizing a changing computing context, that stores a computing context to re-construct the computing context from the stored data later, recognizing the later context to be that of the same computing environment for which the context was stored, if the reconstructed context matches a freshly computed context for more than a preset, passing number of stored context entities.

61. The system of claim 60, wherein after a computing context is recognized, a revised computing context is stored in place of the earlier stored computing context, for more accurate recognition of a computing context later.

62. The system of claim 60, wherein functional data related to the accurate working of the computing environment further comprises the computing context.

63. A distribution system operable in a computing environment for a multimedia and text combination asset comprising a software player that hides one or more keys or cryptography implementation within itself and is bundled with a combination of video, audio, or text data in encrypted form such that the software player can decrypt and play the data or encrypt and add data, without requiring any customer-specific symmetric or asymmetric key or password to be input or made available during installing or running the player.

64. The distribution system of claim 63, wherein the software player thwarts simple data capture mechanisms comprising one or more of screen bitmap capture, screen text clip capture, screen text clipboard capture, or audio clip capture.

65. The distribution system of claim 63, wherein the hidden keys or cryptography implementation of the software player comprises an expiry date or mechanism so that the player does not work after the date or mechanism disallows it.

66. The distribution system of claim 65, further comprising enabling a free or priced update with a continuing player of a different hidden keys or cryptography implementation, upon expiry of the player.

67. The distribution system of claim 66, wherein the update recurs with a well-announced expiry date for planning convenience.

68. The distribution system of claim 63, wherein the data decrypted or encrypted by the hidden keys or cryptography implementation of the software player is reduced to a small partition so that the remaining one or more data partitions may be bundled and distributed with one or more other software players, each comprising distinct hidden keys or cryptography implementation.

69. The distribution system of claim 63, wherein no plaintext fragment of encrypted data is exposed to a user, other than possibly only sale-related input such as buyer details or payment details.

70. A software authentication and installation monitoring system operable in a computing environment for installing authenticated software only on a machine, comprising:
(a) a means for hiding one or more keys or cryptography implementation;
(b) a means for tracking authentic software or certified software or user-built software installed on a machine by storing the information in encrypted form on the machine using the keys or cryptography implementation hidden by the hiding means;
(c) a means for mediating in a software installation, ensuring that authentication steps are carried out that ensure the authenticity of the installed software;
(d) a means for disallowing a user setting the permission of a file to execute, unless the file is known to be built or certified by the user or known to be authentically installed as per the encrypted information kept by the tracking means;
(e) a means for disallowing an executable file to run, unless the file is built or certified by the user or known to be authentically installed as per the encrypted information kept by the tracking means;
(f) a means for stopping a running program, if the running program is found to not be user built or certified, or authentically installed as per the encrypted information kept by the tracking means; and
(g) a means for scanning the machine periodically, resetting the execute permissions of any unknown files.

71. The system of claim 70, further comprising updating an expired or expiring software with a successor software having different hidden keys or cryptography implementation.

72. The system of claim 71, wherein the update recurrs with a well-announced expiry date for planning convenience.

73. The system of claim 72, further comprising installing and periodically updating an authenticated browser.

74. The system of claim 70, wherein no plaintext fragment of encrypted data is exposed to a user.

75. A distribution method operable in a computing environment for binary-encoded digital assets, comprising:
(a) a hiding step for hiding one or more keys or cryptography implementation in a digital asset;
(b) a copying step for receiving a functionally-restricted asset copy for use or further distribution, directly or as a further copy, with or without access to a computer network; and
(c) a self-policing step for enforcing asset safety comprising:
i. an authentication step for an un-authenticated, digital asset for constructing encrypted credentials data using one or more keys or cryptography implementation hidden in the asset, for authentication by an authenticated digital asset or website;
ii. a secure selling step for an authenticated digital asset for either carrying out a sale transaction directly, securely, or delegating the sale to a separate secure means, identifying the delegation by an encrypted identifier constructed using one or more keys or cryptography implementation hidden in the asset and decrypting the response from the secure means using the one or more keys or cryptography implementation hidden in the asset to determine the success of the sale; and
iii. a copyright and license enforcement step for an asset for carrying out encryption and decryption of computing context and other data using one or more keys or cryptography implementation hidden in the asset, with functionally-unrestricted asset use permitted only after the asset has been sold and licensed to run in a recognizable computing context.

76. A cryptography hiding method operable in a computing environment for hiding one or more keys or cryptography implementation in a binary-encoded digital asset using holistic, efficient steganography, comprising:
(a) an interleaving step for interleaving sequentially or concurrently, the computation of non-cryptography, useful code with cryptography code;
(b) an obfuscating memory management step for creating an encoded pointer representation of any scalar, comprising the use of one or more encoding pointers pointing to one or more objects created and managed for maintaining the scalar in an obfuscated state throughout the lifetime of the scalar;
(c) a class obfuscation step for translating a class to one or more data structures or procedures; and
(d) a procedure obfuscation step for de-stacking one or more parameters of a procedure or translating a procedure call to jumps to and from an inlined procedure body.

77. A cryptography hiding method operable in a computing environment for hiding one or more keys or cryptography implementation in a binary-encoded digital asset using holistic, efficient steganography, comprising the step of using an interleaving loop or recursive procedure for instantiating one or more re-entrant calls to one or more procedures or macros in cryptography code, such that one or more re-entrant calls to one or more procedures or macros in useful, non-cryptography code are interspersed in-between any two cryptography code calls, and that a cryptography call typically comprises a smaller stateful computation than a larger stateful computation comprised by a non-cryptography call.

78. An obfuscating memory management method operable in a computing environment for creating an encoded pointer representation of any scalar, comprising the step of using one or more encoding pointers pointing to one or more objects created and managed for maintaining the scalar in an obfuscated state throughout the lifetime of the scalar.

79. An obfuscating memory management method operable in a computing environment comprising the step of allocating or de-allocating an object with meta-data comprising object size or layout such that the contents of the object may be obfuscated by distribution or re-distribution, part by part, anywhere over the object or one or more other objects.

80. A procedure obfuscation method operable in a computing environment for de-stacking one or more procedure parameters, comprising a static analysis step guided by one or more user annotations, and a source-to-source transformation step replacing a reference to a procedure parameter with a non-stack reference.

81. A computing context storing method operable in a computing environment for storing a computing context, comprising a step of storing a computing context within a narrow time window part of the computing context.

82. A computing context recognition method operable in a computing environment for handling and recognizing a changing computing context, comprising the steps of:
(a) Storing a computing context; and
(b) Re-constructing the computing context from the stored data later, recognizing the later context to be that of the same computing environment for which the context was stored, if the reconstructed context matches a freshly computed context for more than a preset, passing number of stored context entities.

83. A distribution method operable in a computing environment for a multimedia and text combination asset comprising a step of encrypting or decrypting a combination of video, audio or text data bundled with a software player, using the hidden keys or cryptography implementation of the software player such that no customer-specific symmetric or asymmetric key or password is required to be input or made available during the installing or running of the player.

84. A software authentication and installation monitoring method operable in a computing environment for installing authenticated software only on a machine, comprising the steps of:
(a) hiding one or more keys or cryptography implementation;
(b) tracking authentic software or certified software or user-built software installed on a machine by storing the information in encrypted form on the machine using the hidden keys or cryptography implementation;
(c) mediating in a software installation, ensuring that authentication steps are carried out that ensure the authenticity of the installed software;
(d) disallowing a user setting the permission of a file to execute, unless the file is known to be built or certified by the user or known to be authentically installed as per the encrypted information kept in the tracking step;
(e) disallowing an executable file to run, unless the file is built or certified by the user or known to be authentically installed as per the encrypted information kept in the tracking step;
(f) stopping a running program, if the running program is found to not be user built or certified, or authentically installed as per the encrypted information kept in the tracking step; and
(g) scanning the machine periodically, resetting the execute permissions of any unknown files.
